(19) United States
(12) Patent Application Publication
(10) Pub. No.: US 2014/0204452 A1
(43) Pub. Date: Jul. 24, 2014

(54) SWITCHABLE LENS APPARATUS AND METHOD

(71) Applicant: sp3 nanotech LLC, Carrollton, TX (US)

(72) Inventor: Blake Tucker Branson, Propser, TX (US)

(73) Assignee: sp3 nanotech LLC, Carrollton, TX (US)

(21) Appl. No.: 14/160,399

(22) Filed: Jan. 21, 2014

Related U.S. Application Data
(60) Provisional application No. 61/754,705, filed on Jan. 21, 2013.

(51) Int. Cl. G02B 26/00

(52) U.S. Cl. CPC G02B 26/004
USPC 359/290

(57) ABSTRACT

A switchable window apparatus capable of being placed in a transparent condition in which light passes through the window unobstructed, and in an obstructed condition in which light passing through the window is obstructed by an optical element in the window. The switchable window apparatus is placed in the transparent state by contacting a lens element with a material of matching refractive index, and placed in the obstructed state by contacting the lens element with a material with a non-matching refractive index.

### CROSS-REFERENCE TO REPLATED APPLICATIONS

This application relates to co-pending U.S. provisional patent application Ser. No. 61/754,705 entitled “Mechanically-Switchable Window or Window Covering for Manipulating Electromagnetic Radiation”, filed Jan. 21, 2013, the entire contents of which are incorporated herein by reference for all purposes.

### BACKGROUND OF THE INVENTION

1. Field of the Invention

The present invention relates to a switchable window apparatus and, more particularly, to a switchable window apparatus capable of being placed in a transparent condition in which light passes through the window unobstructed, and in an obstructed or diffused condition in which light passing through the window is obstructed or diffused by an optical element in the window.

2. Description of the Related Art

A window is an opening in a barrier (such as a building, enclosure and/or protective wall, for example) or material forming a barrier allowing transmission of electromagnetic radiation through at least a portion of the window. Typically, the electromagnetic radiation of concern is visible light, but windows are designed for practically every range of the electromagnetic spectrum: x-ray, ultraviolet, infrared, microwave, and so on. In this disclosure, the term “light” is intended to include the entire electromagnetic spectrum. If a specific and narrow range of the electromagnetic spectrum is intended, the wavelength or range of wavelengths will be explicitly noted.

For reasons of aesthetics, privacy, or otherwise, it is often desirable to control when and how light passes through a window. Windows have been modified with various materials to control the quantity and nature (such as partially transparent, colored, and/or translucent transmission, for example) of light allowed to pass. Windows having coverings, such as curtains, blinds, shades and the like, have been in use for centuries for such lighting control. Additionally, glass, plastic and other examples of transmissive material have conventionally been fabricated with textured surfaces to obscure the view through a window or to diffuse and/or color light passing through the window. An example of such transmissive window material is glass tiles with irregular (wavy) faces distorting light passing through and being viewed through the glass, often found in bathrooms. Another example is retroreflectors, such as those used as safety reflectors on bicycles or on high-visibility road-shoulder markers, which include transparent material (such as glass or a polymer, often colored, for example) with an array of pyramidal or other geometric structures on one side or surface of a lens formed of light-transmissive material. Such tiles, retroreflectors and similar constructions, however, are not suitable for applications where window clarity and clear visibility through the window is desired, because the light transmitted through the window, as well as the corresponding view through the window, is highly distorted. The current state of the art utilizes “smart glass” which consists of electronically-switchable glass panels. These panels employ liquid crystal displays to switch the glass from a transparent state to an opaque or translucent state. Unfortunately, the materials required for this technology result in devices that are prohibitively expensive for many applications.

Windows and window coverings are sometimes designed to manipulate the electromagnetic radiation reflecting from the window. For example, metallic coatings may be applied to one side of transparent glass to allow the glass to serve as a mirror. Or in the case of architectural glazing, a thin coating is applied to a face of the glass to increase reflectivity or absorption characteristics of the material. This may be for aesthetics or to reduce the quantity of radiation (typically sunlight) that enters the structure, enhancing energy efficiency. Drawbacks for such technologies include reduced light transmission through the window, increased temperatures of surroundings on which reflected sunlight falls, and/or negative aesthetics, for example.

A drawback for window materials such as glass (particularly when coated with a reflective layer) is that light may be reflected in an undesirable direction. The direction light reflects from a surface in cases of specular reflection is determined by the direction of the incident light and the direction the window glass extends or faces. This is particularly a challenge for modern curtain-wall buildings having external walls formed virtually entirely by windows, because the glass windows can be an unappealing source of a relatively large amount of sunlight glare reflected onto the surrounding inhabitants, structures and environment.

Accordingly, there is a need for a method and device allowing facile and less costly transformation from a transparent state to a second, non-transparent state (reflective, diffusive, etc.).

### SUMMARY OF THE INVENTION

The present invention provides a switchable window method and apparatus that can be placed in a transparent condition. Alternatively or in addition, the switchable window method and apparatus can be placed in an obstructed (i.e. non-transparent) condition. Newly fabricated windows may comprise the method and apparatus of the invention, or the method and apparatus may be applied to existing and/or previously installed windows.

### BRIEF DESCRIPTION OF THE DRAWINGS

For a more complete understanding of the Detailed Description, reference will be made to the accompanying drawings, in which:

FIG. 1 is a cross-sectional representation of a switchable window apparatus viewed from the side;

FIG. 2 is a perspective view of a switchable window apparatus in an obstructed condition;

FIG. 3 is a representation of an apparatus for controlling the amount of a liquid within the switchable window apparatus of FIG. 2;

FIG. 4 is a perspective view of the switchable window apparatus of FIG. 2 in a partially transparent, partially obstructed condition;

FIG. 5 is a perspective view of a switchable window apparatus in a transparent condition;

FIG. 6 is a perspective view of a lens element for use in the switchable window apparatus;

FIG. 7 is a detail view of a portion of the lens element of FIG. 6;

FIG. 8 is a perspective view of a lens element for use in the switchable window apparatus;

FIG. 9 is a perspective view of a lens element for use in the switchable window apparatus;

FIG. 10 is a perspective view of a lens element for use in the switchable window apparatus;

FIG. 11 is a perspective view of a lens element for use in the switchable window apparatus;

FIG. 12 is a perspective view of a switchable window apparatus;

FIG. 13 is a partially exploded view of the switchable window apparatus of FIG. 12;

FIG. 14 is a perspective view of a switchable window apparatus;

FIG. 15 is a partially exploded view of the switchable window apparatus of FIG. 14;

FIG. 16 is a perspective view of a retrofit kit for existing windows, partially exploded;

FIG. 17 is a perspective view of a retrofit kit for existing windows;

FIG. 18 is a detail, perspective view of a manifold utilized as a connecting member;

FIG. 19 is a perspective view of a retrofit kit for existing windows, partially exploded;

FIG. 20 is a perspective view of a switchable window apparatus;

FIG. 21 is a perspective view of a switchable window apparatus;

FIG. 22 is a cross-sectional representation of a switchable window apparatus viewed from the side;

FIG. 23 is a perspective view of a switchable window;

FIG. 24 is an exploded perspective view, showing lenses separated from the framework and control unit of a switchable window;

FIGS. 25A and B are combined perspective and magnified views showing exemplary surface geometry of a matched pair of lenses;

FIG. 26 is a perspective view exemplary surface geometry an interior lens face;

FIGS. 27A and B are light ray diagrams, illustrating an exemplary path light rays will travel through paired lenses meshed (FIG. 27A) and physically separated (FIG. 27B);

FIG. 28A is a light ray diagram, illustrating an exemplary path a light ray will travel through a male lens with faceted surface features when not in contact with a corresponding female lens;

FIG. 28B is a light ray diagram, illustrating an exemplary path a light ray will travel through two lenses in contact;

FIGS. 29A and 29B are light ray diagrams, illustrating exemplary paths light rays may travel through a switchable window apparatus in obstructed and transparent conditions, respectively;

FIGS. 30A and 30B are light ray diagrams, illustrating exemplary paths light rays may travel through a switchable window apparatus in obstructed and transparent conditions, respectively;

FIGS. 31A and 31B are light ray diagrams, illustrating exemplary paths light rays may travel through a switchable window apparatus in obstructed and transparent conditions, respectively;

FIGS. 32A and 32B are light ray diagrams, illustrating exemplary paths light rays may travel through a switchable window apparatus in obstructed and transparent conditions, respectively;

FIGS. 33A and 33B are light ray diagrams, illustrating exemplary paths light rays may travel through a switchable window apparatus in obstructed and transparent conditions, respectively;

FIG. 34A is a light ray diagram illustrating an exemplary path a light ray may be reflected from an existing window;

FIGS. 34B and 34C are light ray diagrams, illustrating exemplary paths light rays may travel through a switchable window apparatus in obstructed and transparent conditions, respectively;

FIGS. 35A and 35B are light ray diagrams, illustrating exemplary paths light rays may travel through a switchable window apparatus in obstructed and transparent conditions, respectively;

FIGS. 36A and 36B are light ray diagrams, illustrating exemplary paths light rays may travel through a switchable window apparatus in obstructed and transparent conditions, respectively;

FIGS. 37A and 37B are light ray diagrams, illustrating exemplary paths light rays may travel through a switchable window apparatus in obstructed and transparent conditions, respectively;

FIGS. 38A and 38B are light ray diagrams, illustrating exemplary paths light rays may travel through a switchable window apparatus in obstructed and transparent conditions, respectively;

FIGS. 39A and 39B are light ray diagrams, illustrating exemplary paths light rays may travel through a switchable window apparatus in obstructed and transparent conditions, respectively;

FIGS. 40A and 40B are light ray diagrams, illustrating exemplary paths light rays may travel through a switchable window apparatus in obstructed and transparent conditions, respectively;

FIGS. 41A and 41B are light ray diagrams, illustrating exemplary paths light rays may travel through a switchable window apparatus in obstructed and transparent conditions, respectively;

FIGS. 42A and 42B are light ray diagrams, illustrating exemplary paths light rays may travel through a switchable window apparatus in obstructed and transparent conditions, respectively;

FIGS. 43A and 43B are light ray diagrams, illustrating exemplary paths light rays may travel through a switchable window apparatus in obstructed and transparent conditions, respectively;

FIGS. 44A and 44B are light ray diagrams illustrating exemplary paths light rays may travel through a switchable window apparatus in obstructed and transparent conditions, respectively;

FIG. 45 is a block diagram of switchable window units and a central control system;

FIG. 46 is a block diagram of a control system for a switchable window unit; and

FIGS. 47-50 are flow charts illustrating methods of practicing the invention.

### DETAILED DESCRIPTION

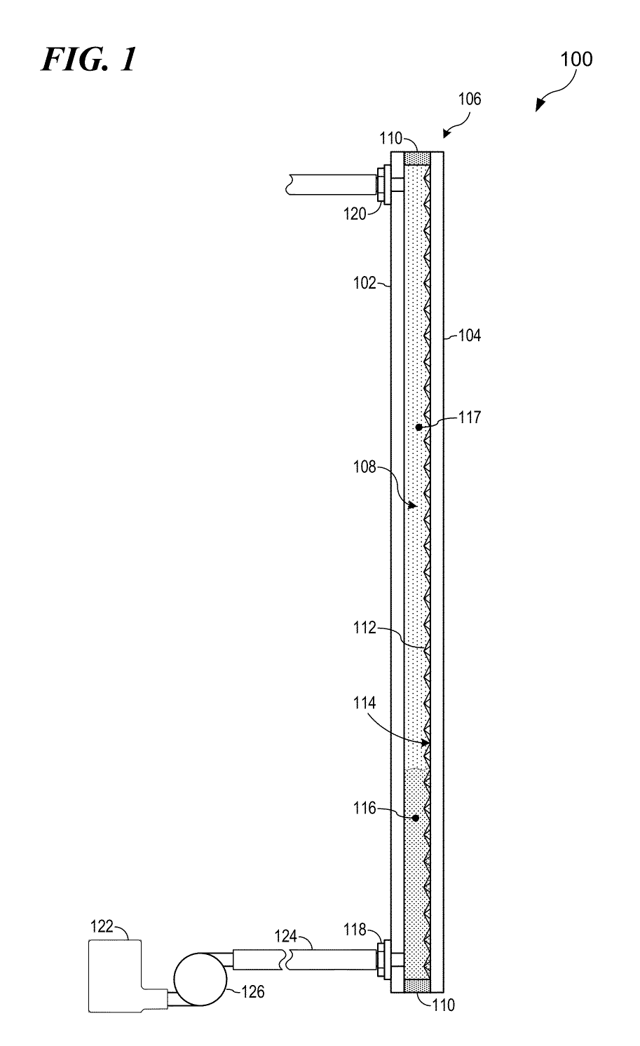

According to one aspect of the invention, and as shown in FIG. 1, a switchable window apparatus 100 for a window may have a first transparent member 102, such as a pane of glass or the like, coupled to a second, preferably substantially rigid, transparent member 104, such as a pane of glass or the like, to form a double-paned transparent window unit 106 having an interior cavity 108. The first and second transparent members 102, 104 may be coupled together, and the interior cavity 108 sealed, by any suitable sealing material and method, such as for example using any suitable glazing material 110 or the like. Preferably the glazing material 110 used forms a gas-tight and liquid-tight seal between the first and second transparent members 102, 104.

Typically one of the transparent members, or panes, will be oriented on and/or form at least a portion of an interior side of the window, and the other pane will be oriented on and/or form at least a portion of an exterior side of the window. Each of the two panes will have an interior surface facing the interior cavity, and each of the two panes will have an exterior surface opposite its respective interior surface. The apparatus shown in FIG. 1 is configured with first transparent member 102 oriented on the interior side of the window and second, substantially rigid transparent member 104 oriented on the exterior side of the window as the outer pane.

A lens layer 112 may be provided on the interior surface 114 of the second transparent member 104 for having an optical effect upon incident light striking the lens layer 112. The lens layer 112 may be a transparent material having a textured, lenticular, prismatic or other non-planar surface for example, for diffusing, diffracting, refracting, reflecting, or otherwise altering the path of incident light upon the window unit in a non-uniform manner. Incident light of which its path has been altered in a non-uniform manner is herein said to be “obstructed”, such that two parallel light rays entering the lens layer 112 would not be parallel after passing through the lens layer 112. The lens layer 112 may have any sort of texture or other non-planar surface that presents a non-uniform surface to incident light, and therefore provides an optical effect of scattering the light in many directions or reduces transmission through the lens layer 112. Surfaces that achieve this scattering optical effect include, for example, sandblasted surfaces, wavy surfaces, fritted glass surfaces, ridged surfaces, and other non-planar surfaces. Other surfaces that may reduce transmission through the lens layer 112 to achieve this scattering optical effect may include surfaces that are also retro-reflective under certain conditions. In an embodiment, the transparent material of lens layer 112 may be a silicone rubber material that is both transparent and flexible. The lens layer 112 may be utilized to obstruct or distort the view through the window unit, as with so-called privacy glass. The lens layer may also or alternatively be designed primarily to redirect incident light in a particular direction, or away from a particular direction.

The interior cavity 108 may be at least partially filled with an index-matching fluid 116 having an index of refraction that matches an index of refraction of the material of the lens layer 112. In the example shown in FIG. 1, the index-matching fluid 116 may be a liquid that displaces a non-matching fluid 117 such as air. As the cavity 108 fills with the index-matching fluid 116, displacing the non-matching fluid 117, the effect of the lens layer 112 is negated because there is no longer a mismatch between the index of refraction of the material of lens layer 112 and vacuum, air, other gas or other non-matching fluid 117 or other material previously occupying the cavity 108 containing the index-matching fluid 116. In the portion of the window unit 106 where the index-matching fluid 116 fills a portion of the cavity 108 adjacent a corresponding portion of lens layer 112, the index of refraction of the index-matching fluid 116 matches the index of refraction of the material of lens layer 112, such that there is no noticeable optical effect of diffusing, diffracting, refracting, reflecting, or otherwise affecting transmission of light through the lens layer 112 and the switchable lens apparatus 100 of the window unit 106 will occur, and the view through the window unit 106 will no longer be obstructed. It will be appreciated that the indexes of refraction of the lens layer 112 and the index-matching fluid 116 or other material within the cavity 108 may differ so as to reduce, but not eliminate, noticeable obstruction or to change the amount of diffusion, diffraction, refraction, reflection or other adjustment of light transmitted. The refractive index (nD) may differ between the two materials by no more than about 0.01 (i.e., a lens with a refractive index nD=1.415 can be “matched” to fluids with an nD from 1.405 to 1.425). Ideally, the indices may be within about 0.005 of each other. Additionally or alternately, the index-matching fluid 116 or other material within the cavity 108 may filter light to transmit or block a particular wavelength, range of wavelengths and/or plurality of wavelengths, such as a particular color, color combination of, or all light. A combination of materials may also be introduced to the cavity 108, such as a plurality of liquids 116 having differing indices of refraction and/or a combination of liquids and solids in suspension to diffuse, diffract, refract, reflect or otherwise adjust light passing through the cavity 108.

The window unit 106 may be placed in at least two conditions: a first, obstructed, condition in which the interior cavity 108 is not filled with the index-matching fluid 116 and transmission of light through the window unit 106 is affected by lens layer 112; and a second, transparent, condition in which the interior cavity 108 is filled with the index-matching fluid 116 and transparent transmission of light through the window unit 106 is not noticeably affected by lens layer 112. The index-matching fluid 116 may be conveyed into and out of window unit 106 via a first port 118, which may be a fitting provided at or near the bottom of the window unit 106 and coupled to the interior cavity 108 for accommodating a flow of index-matching fluid 116 into or out of the interior cavity 108. A second port 120, which may be a fitting provided at or near the top of the window unit 106, may be coupled to the interior cavity 108 for accommodating a flow of air or other gas into or out of the cavity 108, to equalize air pressure between the interior cavity 108 and ambient air pressure.

The index-matching fluid 116 may be forced under pressure into the interior cavity 108 through port 118, thereby forcing a corresponding volume of air or other gas out of the interior cavity 108 through port 120. Alternatively, air or other gas may be evacuated from the interior cavity through port 120, thereby drawing the index-matching fluid 116 into the interior cavity from a reservoir 122. In an embodiment, the reservoir 122 may be separate vessel connected via tubing 124 or the like to port 118 of window unit 106. A pump 126 may be coupled to the reservoir via suitable tubing 124, and may be coupled to port 118 of the window unit 106 for forcing index-matching fluid 116 into the interior cavity 108 or drawing the index-matching fluid 116 out of the interior cavity 108. The pump 126 may be operated by any manual, electric, pneumatic, hydraulic, or other means depending upon the particular application of the switchable lens apparatus 100. The pump may be operated in a first mode, forcing index-matching fluid 116 into the window unit 106 until the interior cavity 108 is substantially full of the index-matching fluid 116, at which point operation of the pump 126 may stop, and the window unit 106 will be in the transparent condition. The pump 126 may be operated in a second mode, drawing index-matching fluid 116 out of the window unit 106 until the interior cavity 108 is substantially empty of the index-matching fluid 116, at which point operation of the pump 126 may stop, and the window unit 106 will be in the obstructed condition.

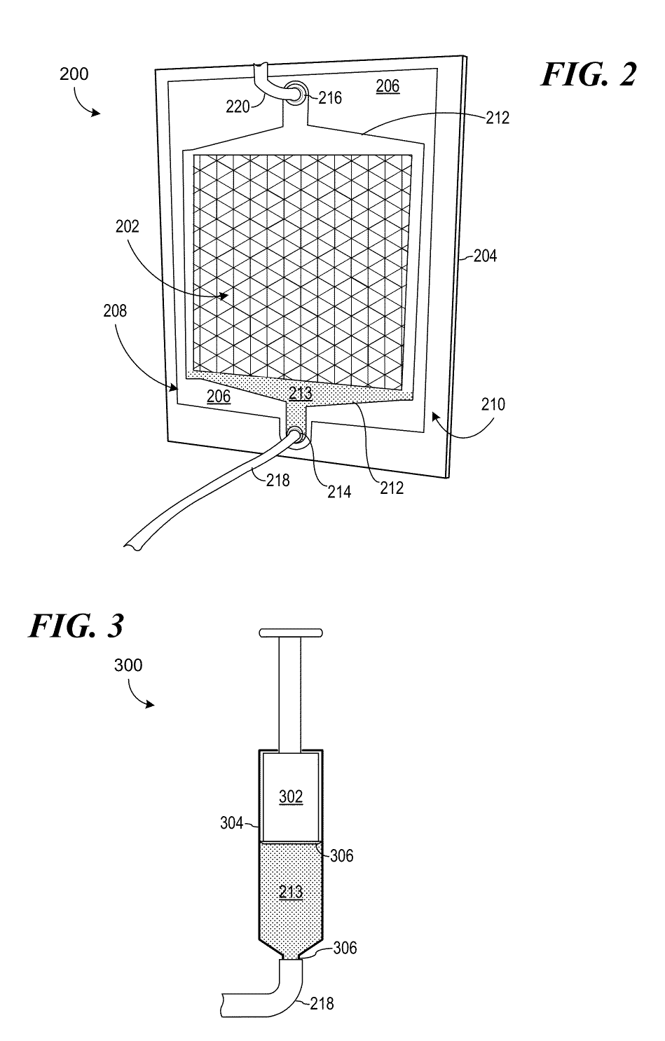

Turning now to FIG. 2, another configuration of a window unit 200 is shown, in which a prismatic lens array 202 is supported on a substantially rigid transparent member 204, such as a pane of glass or the like, extending over most of the area of the first transparent member 204, but leaving peripheral portions 206 of the first transparent member uncovered. A second transparent member 208, of approximately the same size in height and width as the first transparent member 204, may be placed over the prismatic lens array 202, and the peripheral portions of the second transparent member 208 may be adhered to the peripheral portions of the first transparent member 204. The second transparent member 208 may have some degree of flexibility in order to bend and thereby be displaced slightly out of contact with or past the extents of prismatic lens array 202 while adhering to the first transparent member 204 at peripheral portions 206 thereof. The peripheral portions of the first and second transparent members 204 and 208 may be covered and sealed by a suitable masking layer 210 which may be, for example, one or more pieces of strong and durable adhesive tape folded over the peripheral edges of first and second transparent members 204, 208. The prismatic lens array 202 is thereby disposed within a cavity 212 formed between first transparent member 204 and second transparent member 208, similarly to the way cavity 108 is formed between the first transparent member 102 and the second transparent member 104 shown in FIG. 1. As shown in FIG. 2, the cavity 212 may extend downward to encompass and couple with a first port 214, and may extend upward to encompass and couple with a second port 216.

The cavity 212 may be at least partially filled with an index-matching fluid 213 having an index of refraction that matches an index of refraction of the material of the prismatic lens 202. The first port 214 may be a fitting provided at or near the bottom of the window unit 200 and coupled to the cavity 212 for accommodating a flow of index-matching fluid 213 into or out of the cavity 212. The second port 216 may be a fitting provided at or near the top of the window unit 200, may be coupled to the cavity 212 for accommodating a flow of air or other gas into or out of the cavity 212, to equalize air pressure between the cavity 212 and ambient air pressure. The first port 214 may be coupled to a source of liquid by suitable tubing 218, or some other suitable conveyance. The second port 216 may be coupled to a vent to ambient atmosphere by suitable tubing 220, or some other suitable conveyance.

As shown in FIG. 3, a suitable source of the index-matching fluid 213 may be an apparatus 300 having a piston 302 disposed within a cylinder 304, the piston 302 having a gasket 306 or other suitable sealing member at one end thereof, and may be similar to a syringe. The cylinder 304 may be tapered at one end to form an outlet 308 suitable for coupling to tubing 218 or other suitable conveyance. Tubing 218 may be coupled to the first port 214, as shown in FIG. 2, for providing a flow of index-matching fluid 213 into or out of the cavity 212. The apparatus 300 may serve as a reservoir for index-matching fluid 213, and may hold a certain amount of index-matching fluid 213 within the cylinder 304 adjacent the outlet 308. The apparatus 300 may also serve as a pump, wherein the piston 302 may be moved downward towards the outlet 308, thereby forcing the index-matching fluid 213 out of the cylinder 304 and into tubing 218, and thereafter into cavity 212 of window unit 200 as shown in FIG. 2. The piston 302 may be moved upward away from the outlet 306, thereby drawing index-matching fluid 213 into the cylinder 304 from tubing 218 and cavity 212. The piston may be operated manually by pushing or pulling on handle 310 coupled to piston 302, or by any suitable mechanical or motorized means.

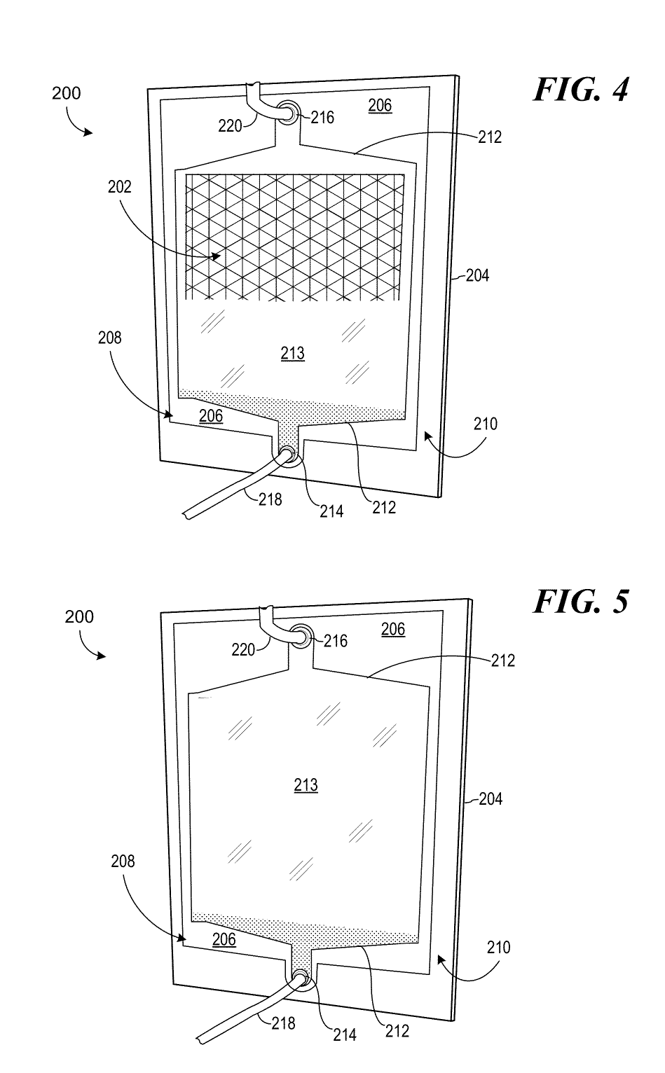

Turning now to FIG. 4, the window unit 200 is shown having the index-matching fluid 213 forced into a lower portion of the cavity 212, such that the level of the index-matching fluid 213 is about halfway up the cavity 212. In the portion where the index-matching fluid 213 is in contact with the prismatic lens 202, the effect of the prismatic lens 202 is substantially negated because there is no longer appreciable difference or mismatch between the index of refraction of the material of prismatic lens 202 previously existing between any air or other gas occupying the space within cavity 212 displaced by the index-matching fluid 213. The window unit 200 thus becomes transparent in the portion containing the index-matching fluid 213.

Turning now to FIG. 5, the window unit 200 is shown having the index-matching fluid 213 forced most of the way into the cavity 212, such that the level of the index-matching fluid 213 is up to the level of the top of prismatic lens 202. In this condition, the effect of the prismatic lens 202 is negated and the window unit 200 becomes transparent, preferably in the entire area over which the lens extends.

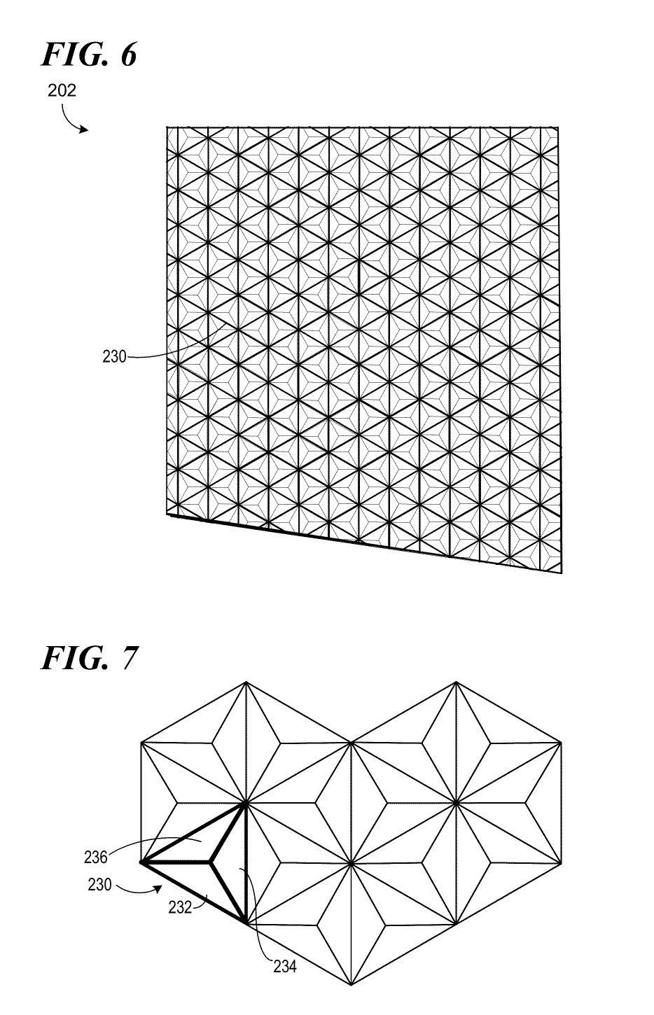

Turning now to FIGS. 6 and 7, the prismatic lens array 202 may comprise, for example, a hexagonal array of triangular pyramidal prismatic shapes 230. Each of the shapes 230 may have three generally planar surfaces 232, 234, 236 each inclined at an angle from a general plane of the prismatic lens 202. Other types of lens elements may be used depending upon the desired effect of the window unit in the obstructed condition. Lens elements such as the prismatic lens array 202 may be fabricated from a transparent material having a known index of refraction. To be capable of being switched to a substantially transparent window the lens array 202 and index-matching fluid 213 materials are selected to have closely matching or identical optical properties such as refractive indices, dispersion, and haze.

It is well-known that different materials have different indices of refraction, and techniques for adjusting or altering the refractive index of light-transmissive materials are also well-known. For example, a mixture of roughly three parts ethylene glycol to one part water, or more precisely, 77% ethylene glycol and 23% water, is a liquid fluid having an index of refraction that matches a certain polymer material, for example a silicone elastomer, such as the Solaris® silicone rubber product available from Smooth-On, Inc. of Easton, Pa. The refractive index (nD) may differ between the two materials by no more than about 0.01 (i.e., a lens with a refractive index nD=1.415 can be “matched” to fluids with an nD from 1.405 to 1.425). Ideally, the indices may be within about 0.005 of each other. Alternatively, certain low-viscosity silicone oils may have an index of refraction that matches a certain polymer material, for example polymethylmethacrylate. The choice of index-matching fluid may also depend upon the intended application of the window unit. A wide variety of materials and index-matching liquids and other fluids may be used to attain the desired light adjustment. It should also be noted that a wide variety of physical configurations of lens elements may also be used depending upon the desired effect of the window unit 106 or 200 in the obstructed condition. The effective surface, the refractive or diffusive surface, of the lens element need not be uniform, however the lens material must be transparent.

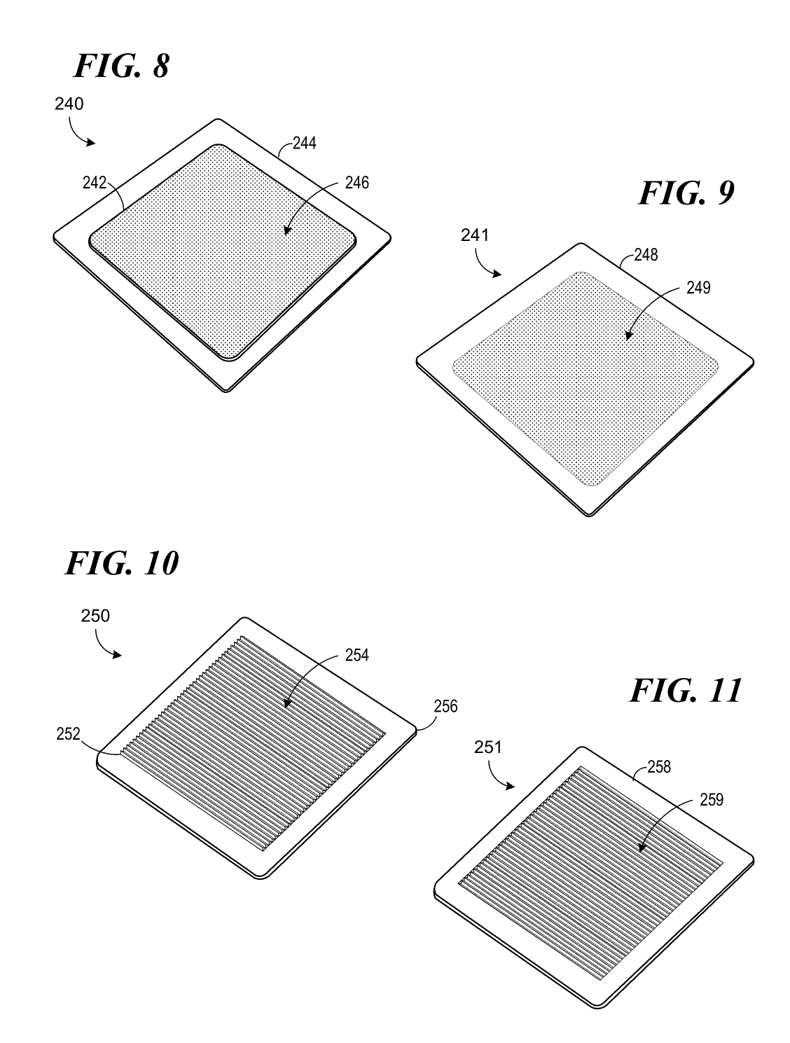

Turning now to FIGS. 8-11, a variety of different types of lens elements are shown which may have a textured, lenticular, prismatic or other non-planar surface for example, for diffusing, diffracting, refracting, reflecting, or otherwise altering the path of incident light upon the window unit in a non-uniform manner, thereby obstructing incident light. For example, FIG. 8 illustrates a lens element 240 having a generally planar polymer lens 242 adhered on one surface of a transparent substrate 244, such as a pane of glass or the like, the polymer lens 242 having a lightly stippled surface 246 opposite the transparent substrate 244. Alternatively, and as shown in FIG. 9, a lens element 241 may be a transparent substrate 248 having a lightly stippled or “frosted” surface 249 without a separate polymer lens on the surface. The index-matching fluid should sufficiently matches the index of refraction of the lens 242 or substrate 248 to allow the lens apparatus to transparently transmit light without noticeable adjustment or change.

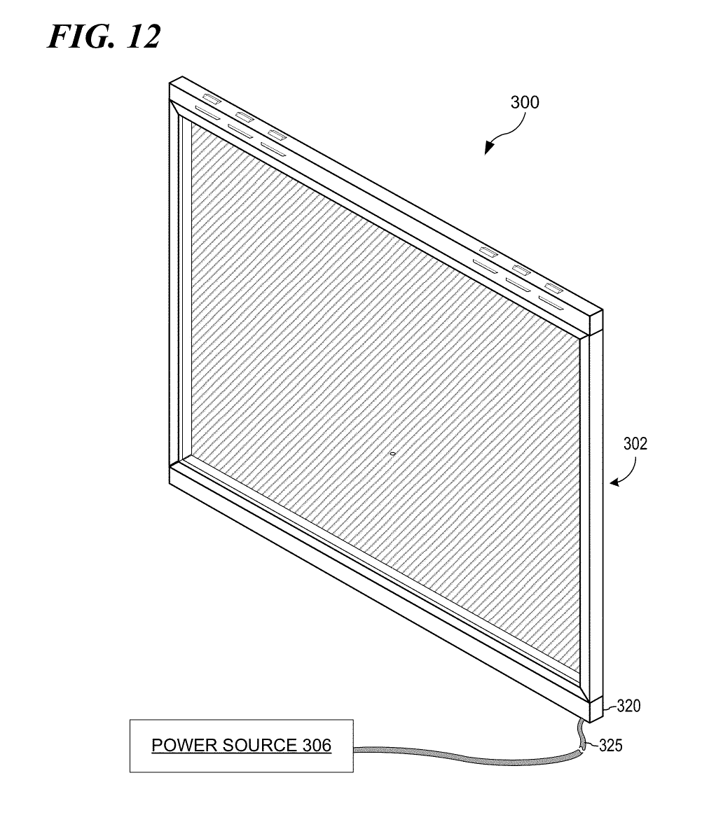

FIG. 10, for example, illustrates a lens element 250 having a generally planar polymer lens 252, having a grooved surface 254, coupled to a transparent substrate 256 such as a pane of glass or the like. Alternatively, as shown in FIG. 11, a lens element 251 may be a transparent substrate 258 having a grooved surface 259, instead of having a separate polymer lens element with its grooved surface. To allow the lens apparatus to transparently transmit light without noticeable adjustment or change, the index-matching fluid should sufficiently match the index of refraction of the lens element material or substrate (e.g., polymer lens 252 and transparent substrate 258) the index-matching fluid will contact and directly transmit light to or receive light from.

Accordingly, the lens surface in contact with the liquid shown in FIGS. 8 through 11 may be formed by etching, cutting, molding or other suitable techniques a material placed on the transparent substrate, having the same or a different index of refraction from the substrate material, or directly on or by the substrate material.

It should be noted that any surface pattern, texture, treatment, or other configuration of surface features greater in size than 700 nm will have some optical effect on light passing through a window unit equipped with a lens element according to the present invention. Features having an optical effect will typically be at least about 10 μm (microns), and may range in size from about 10 microns to about 1 cm. Features smaller than the wavelength of light cannot be expected to have an obstructing optical effect on the light passing through those features. However, having smaller features tends to reduce the volume of index-matching fluid required in a typical window unit according to the present invention. Larger surface features, such as the prismatic lens 202 shown in FIG. 2, tend to leave more empty space in the interior cavity 212 to be filled by the index-matching fluid 213, than smaller features, such as the light stippling of the lens element 240 as shown in FIG. 8. Therefore, having smaller features leaves less empty space in the cavity to be filled by the index-matching fluid.

Window units such as those described may be used as an original architectural feature, or as a replacement window unit. Existing windows may also be retro-fit with additional components to create a window such as those described. An original or replacement window unit may provide the first and second transparent substrates with a lens element disposed within a cavity between the two substrates, and means for moving an index-matching fluid into or out of the cavity. A retro-fit kit may be installed onto an existing window pane which may serve as one of the transparent substrates. The retro-fit kit may provide the second transparent substrate with lens element, means for sealing a cavity between the two transparent substrates, and means for moving an index-matching fluid into or out of the cavity. A retro-fit kit may alternatively provide a lens element to be placed on an existing window, together with a second transparent substrate, means for sealing a cavity between the two transparent substrates, and means for moving an index-matching fluid into or out of the cavity.

A transparent substrate may take the form of a durable, flexible, and transparent film of a plastic material, such as polymethyl methacrylate (PMMA), polycarbonate, polyethylene terephthalate (PET), or amorphous fluoropolymers. In certain instances, the transparent substrate may comprise multiple layers of transparent films chosen for their specific properties, such as transparency, durability, optical stability, scratch- and chemical-resistance and the like. Certain layers may be provided for their UV or infra-red (IR) filtering properties, and may be in addition to other layers provided for other properties, such as durability when exposed to the elements, or stability when exposed to sunlight or other forms of electromagnetic (EM) radiation.

### First Original/Replacement Window Configuration

Turning now to FIG. 12, a switchable window system 300 according may be constructed as original architectural feature, or as a replacement unit, with a switchable window unit 302, a control subsystem 320 coupled to the window unit 302, and a connection 325 from the control subsystem 320 to a power source 306. Note that the power source 306 may be any source of electrical power, a source of compressed air or other gas, a source of pressurized hydraulic fluid or other suitable power source.

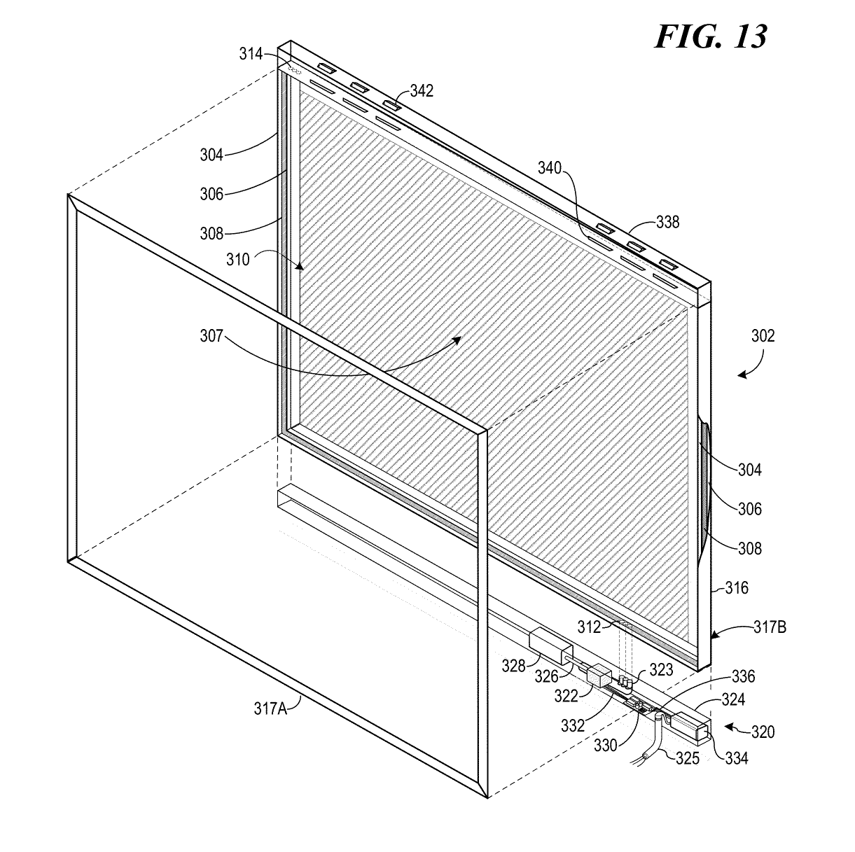

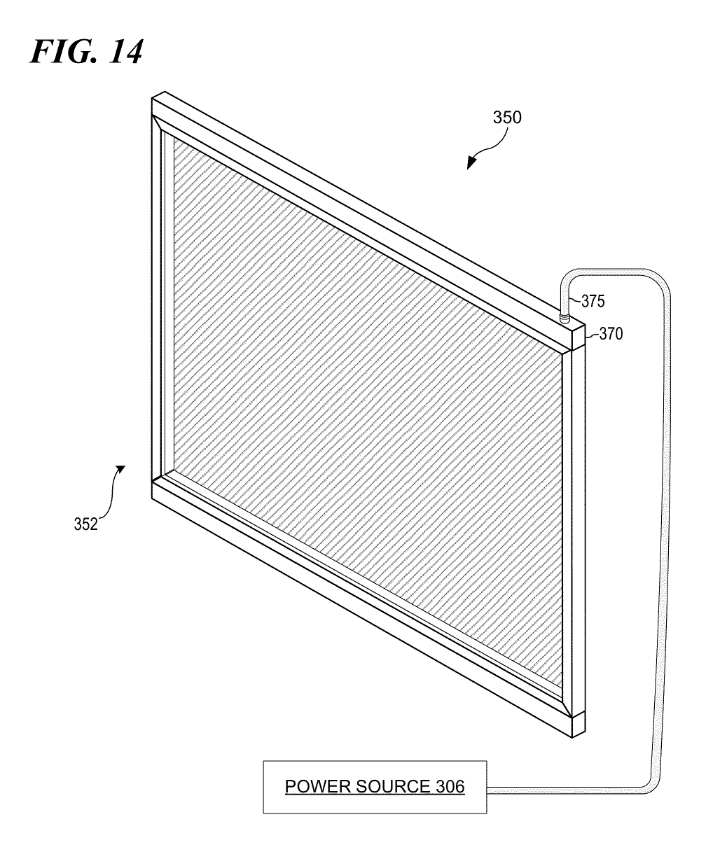

As shown in FIG. 13, the switchable window unit 302 may be similar to window unit 106 shown in FIG. 1, or window unit 200 shown in FIG. 2, having first transparent substrate 304 and second transparent substrate 306, with a lens element 307 on an interior surface of the second substrate 306, the first and second transparent substrates 304, 306 being sealed around their peripheral portions by a sealing layer 308. The lens element 307 may be formed on a surface of either the first or second transparent substrate, or may be a separate lens coupled to a surface of either the first or second transparent substrate, and may be disposed within a sealed cavity 310 between the two transparent substrates 304 and 306, with a first port 312 for accommodating a flow of index-matching fluid into and out of the cavity 310, and a second port 314 for evacuating gas located within the cavity 310. The window unit may be disposed within a frame 316, the frame 316 extending around the peripheral edges of the window unit 302, enclosing peripheral edges of first and second transparent substrates 304, 306 with facing portions 317A, 317B of the frame 316. In FIG. 13, facing portion 317A of frame 316 is shown exploded away from the rest of the frame 316 for clarity, and one edge of frame 316 is cut away, to show the relative position and configuration of edges of the first transparent member 304, second transparent member 306, and sealing layer 308.

The control system 320 is shown in FIG. 13 exploded away from the window unit 302 to illustrate exemplary components. In this embodiment of the invention, the index-matching fluid is forced into the cavity 310 of window unit 302 through first port 312 by operation of a liquid pump 322, which may be disposed within a first housing 324 coupled to the bottom of frame 316. In FIG. 13, the housing 324 is shown as transparent for the purpose of illustrating the housed components; however, for aesthetic reasons, the housing 324 would likely be an opaque structure, typically of the same metal or other material as the frame 316. The pump 322 may be connected to first port 312 via a connecting member 323, which may be a manifold as shown in FIG. 13 or may be any other suitable liquid-conveyance device, such as flexible tubing, for example. The pump 322 may be connected via tubing 326 or other suitable liquid-conveyance device, such as a pipe, for example, to a reservoir 328. The reservoir may preferably be of a size sufficient to contain a quantity of the index-matching fluid (not shown) needed to fill the cavity of window unit 302 while the window unit 302 is in the unobstructed, or clear, condition. Conversely, substantially all of the index-matching fluid may be stored in the reservoir 328 when the index-matching fluid is removed from the window unit 302 and the window unit 302 is in the obstructed condition. Alternatively, the reservoir 328 may be made of a flexible material such that the reservoir 328 is expandable to accommodate a flow of index-matching fluid into the reservoir 328. The pump 322 may be coupled to an electronic controller 330 via suitable wiring 332 or other suitable electrical conveyance. Electrical power for operating the pump 322 and the electronic controller 330 may be provided by a power module 334, which may be a typical electronic power supply converting alternating-current (AC) line voltage to whatever direct current (DC) operating voltages are required by the electronic controller 330 and, if necessary, the pump 322. The power module 334 may be connected to a source of AC line voltage via a power cable 325, or other suitable electrical conveyance. The power module 334 may be electrically coupled to electronic controller 330 by suitable wiring 336 or other suitable electrical conveyance. A second housing 338 may be coupled to the top of frame 316, if desired, for enclosing the second port 314. The second housing 338 may be vented to a reservoir or to ambient atmosphere by any suitable means, such as louvers 340 formed in the sides of the housing, or slots 342 formed in the top of the housing.

### Second Original/Replacement Window Configuration

Turning now to FIG. 14, a switchable window system 350 may be constructed as original architectural feature, or as a replacement unit with a switchable window unit 352, a control subsystem 370 coupled to the window unit 352, and a connection 375 from the control subsystem to a power source 306. Note that the power source 306 may be any source of electrical power, a source of compressed air or other gas, a source of pressurized hydraulic fluid, or other suitable power source.

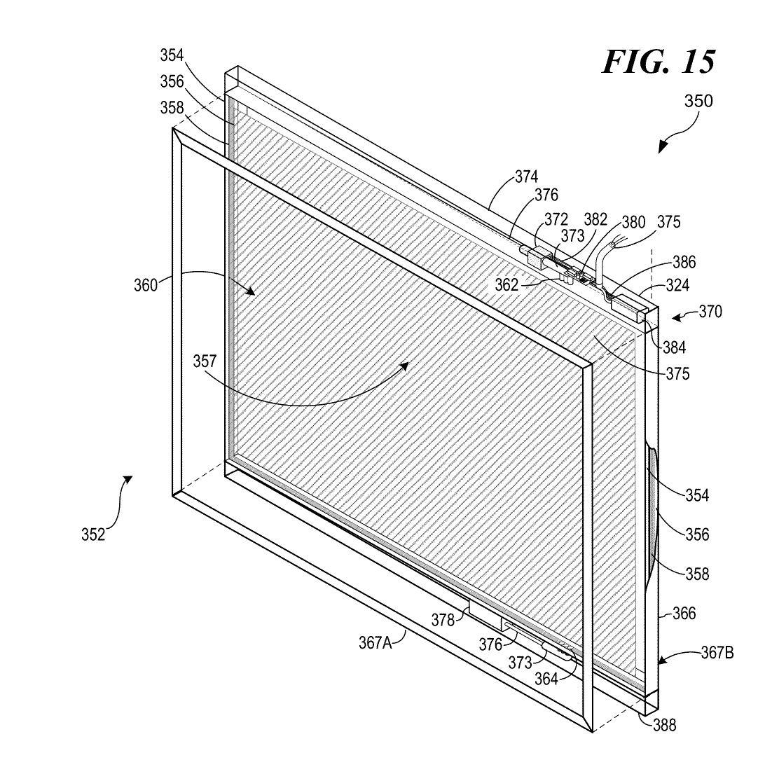

As shown in FIG. 15, the switchable window unit 352 may be similar to window unit 106 shown in FIG. 1, or window unit 200 shown in FIG. 2 or to switchable window system 300 shown in FIG. 12, or to switchable window unit 302 as shown in FIG. 13. The switchable window unit 352 may have a first transparent substrate 354 and second transparent substrate 356, with a lens element 357 on an interior surface of the second substrate 356, the first and second transparent substrates 354, 356 being sealed around peripheral portions thereof by a sealing layer 358. The lens element 357 may be formed on a surface of either the first or second transparent substrate, or may be a separate lens coupled to a surface of either the first or second transparent substrate, and may be disposed within a sealed cavity 360 between the two transparent substrates 354 and 356, with a first port 362 for evacuating air or other gasses from the cavity 360, and a second port 364 for accommodating a flow of index-matching fluid into and out of the cavity 360. The window unit may be disposed within a frame 366, the frame 366 extending around the peripheral edges of the window unit 352, enclosing peripheral edges of first and second transparent substrates 354, 356 with facing portions 367A, 367B of the frame 366. In FIG. 15, facing portion 367A of frame 366 is shown exploded away from the rest of the frame 366 for clarity, and one edge of frame 366 is cut away, to show the relative position and configuration of edges of the first transparent member 354, second transparent member 356, and sealing layer 358.

The control system 370 is shown in FIG. 15 coupled to the window unit 352. In this embodiment of the invention, the index-matching fluid is drawn into the cavity 360 of window unit 352 through first port 362 by operation of a vacuum pump 372, which may be disposed within a first housing 374, coupled to the top of frame 366. In FIG. 15, the housing 374 is shown as transparent for the purpose of illustrating the housed components therein; however, for aesthetic reasons, the housing 374 would likely be an opaque structure, typically of the same metal or other material as the frame 366. The pump 372 may be connected to first port 362 via a connecting member 373, which may be a manifold as shown in FIG. 15 or may be any other suitable fluid-conveyance device, such as flexible tubing, for example. The pump 372 may be coupled to an electronic controller 380 via suitable wiring 382 or other suitable electrical conveyance. Electrical power for operating the pump 372 and the electronic controller 380 may be provided by a power module 384, which may be a typical electronic power supply converting alternating-current (AC) line voltage to whatever direct current (DC) operating voltages are required by the electronic controller 380 and, if necessary, the pump 372. The power module 384 may be connected to a source of AC line voltage via a power cable 375, or other suitable electrical conveyance. The power module 384 may be electrically coupled to electronic controller 330 by suitable wiring 386 or other suitable electrical conveyance. A second housing 388 may be coupled to the bottom of frame 366, for enclosing the second port 364.

The second port 364 may be connected to a reservoir 378 via a connecting member 373, which may be a manifold as shown in FIG. 15 or may be any other suitable liquid-conveyance device, such as flexible tubing 376 or other suitable liquid-conveyance device, such as a pipe, for example. The reservoir 378 may preferably be of a size sufficient to contain a quantity of the index-matching fluid (not shown) needed to fill the cavity of window unit 352 while the window unit 352 is in the unobstructed, or clear, condition. Conversely, substantially all of the index-matching fluid may be stored in the reservoir 378 when the index-matching fluid is removed from the window unit 352 and the window unit 352 is in the obstructed condition. Alternatively, the reservoir 378 may be made of a flexible material such that the reservoir 378 is expandable to accommodate a flow of index-matching fluid into the reservoir 378.

### First Retrofit Kit Configuration

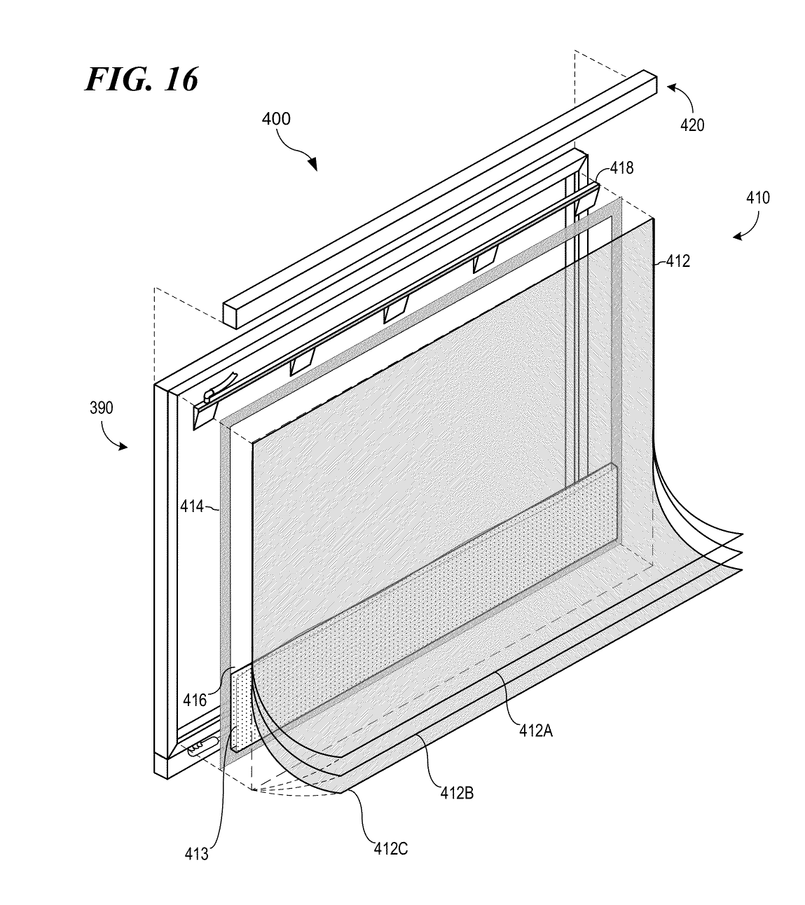

Turning Now to FIG. 16, and in accordance with another aspect of the invention, a switchable window apparatus 400 may be formed by installing a retrofit kit 410 upon an existing window 390. The retrofit kit 410 may have a transparent lens film 412, a quantity of adhesive sealing material 414, and a quantity of index-matching fluid 413. The transparent lens film 412 may be multiple layers 412A, 412B, 412C of flexible, transparent films having different properties, shown partially separated for emphasis, and laminated or otherwise suitably secured together into a single, flexible, transparent film 412. The interior facing layer, such as layer 412C, for example, may be a lens layer having certain refractive, reflective, diffracting, diffusing, or other properties affecting or adjusting transmission of light through a window unit. The index-matching fluid 413 may, to provide a transparent state of the window, be chosen or formulated to match the index of refraction of the lens film 412. Alternatively, the materials of the lens film 412 may be chosen or formulated to match the index of refraction of a preferred index-matching fluid 413. Peripheral edges of the lens film 412 may be adhered and sealed to an exterior pane of existing window unit 390 by the use of adhesive sealing material 414 between the exterior pane of existing window unit 390 and the peripheral edges of lens film 412. A quantity of the index-matching fluid 413 may be contained within a cavity 416 between the exterior pane of existing window unit 390 and flexible lens film 412. A manifold 418 may be coupled to the exterior pane of existing window unit 390 to provide access for fluid communication with cavity 416. The retrofit kit 410 may further include a control system 420 for operating the switchable window apparatus 400.

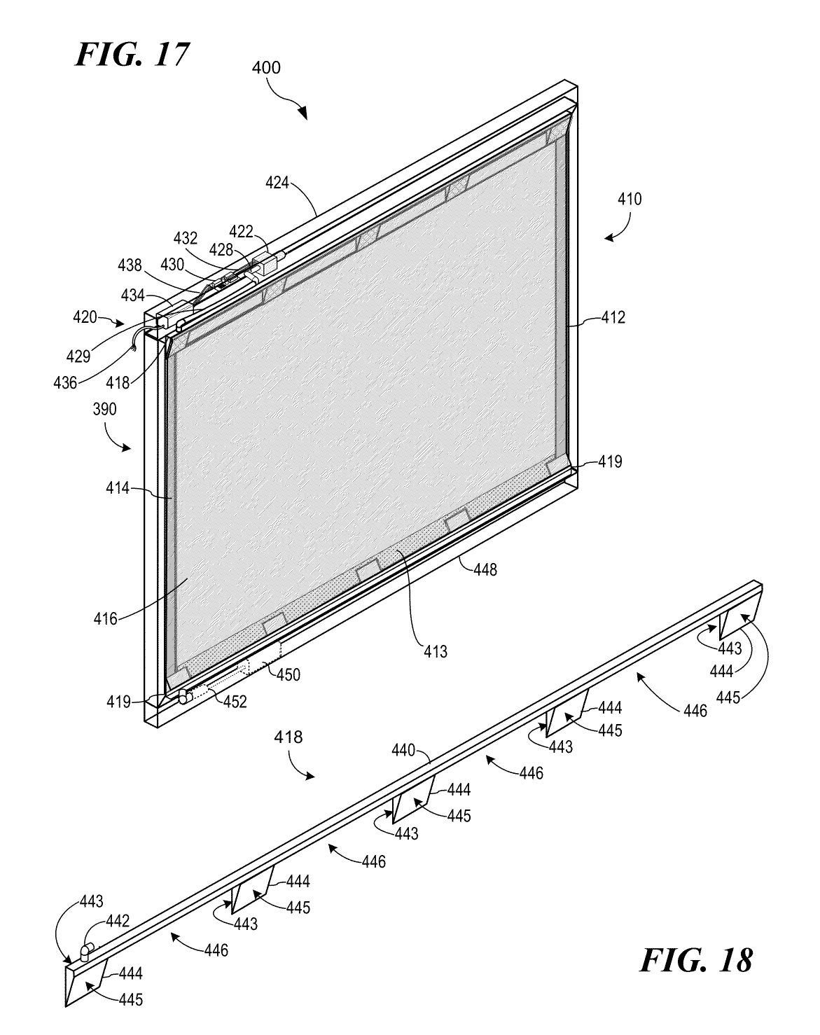

Turning now to FIG. 17, the switchable window unit 400 is shown with the retrofit kit 410 fully installed upon existing window 390. The transparent film 412 is shown adhered about peripheral edges to the exterior pane of existing window unit 390 by adhesive material 414, with a quantity of index-matching fluid 413 contained with the cavity 416 between the exterior pane of existing window unit 390 and lens film 412. The control system 420 is shown installed above the existing window unit 390 as a “header box” containing means for manipulating gases and index-matching fluid 413 into or out of the cavity 416 or within the cavity 416.

The control system 420 is shown in FIG. 17 as being coupled to the existing window 390, in a header space above the existing window 390 The index-matching fluid 413 is drawn into the cavity 416 between the exterior pane of existing window unit 390 and lens film 412 by operation of a vacuum pump 422, which may be disposed within a first housing 424, which may be installed above existing window 390. In FIG. 17, the housing 424 is shown as transparent for the purpose of illustrating the housed components therein; however, for aesthetic reasons, the housing 424 would likely be an opaque structure, typically made of a suitable metal or other material. The pump 422 may be connected to the cavity 416 via a connecting member 428, which may be a fitting provided as an outlet port as shown in FIG. 17, or may be any other suitable fluid-conveyance device, such as flexible tubing, for example. In this instance, the outlet port, or connecting member 428, may be connected via tubing 429 to the manifold 418.

As shown in FIG. 18, the manifold 418 may be an elongated member having a width approximately equal to the width of existing window 390 and the lens film 412. The manifold 418 may have a plenum 440 providing a partially-enclosed hollow space extending the length of manifold 418. An inlet port 442 may be provided leading into the plenum 440. The underside of plenum 440 may open to provide fluid communication between the cavity 416 and the vacuum pump 422, via tubing 429 and connecting member 428. The elongated manifold 418 may be provided with wedge-shaped extensions 444, which may be solid in the portions below the hollow plenum 440. The back sides 443 of extensions 444 provide an area for adhering to an exterior pane of glass of an existing window unit, and provide surfaces 445 on the front faces of the sloping extensions 444 for adhering the top-most portion of lens film 412 to the manifold 418. Spaces 446 between extensions 444 provide fluid communication between the plenum 440 and the cavity 416. Alternatively, the manifold 418 may be composed of multiple, interlocking segments, allowing for constructing manifolds of different, specific lengths, or simply for ease of installation.

Referring to FIG. 17, the pump 422 may be coupled to an electronic controller 430 via suitable wiring 432 or other suitable electrical conveyance. Electrical power for operating the pump 422 and the electronic controller 430 may be provided by a power module 434, which may be a typical electronic power supply converting alternating-current (AC) line voltage to whatever direct current (DC) operating voltages are required by the electronic controller 430 and, if necessary, the pump 422. The power module 434 may be connected to a source of AC line voltage via a power cable 436, or other suitable electrical conveyance. The power module 434 may be electrically coupled to electronic controller 430 by suitable wiring 438 or other suitable electrical conveyance. In certain embodiments, index-matching fluid 413 may be allowed to collect at the bottom of cavity 416 when the switchable window unit 400 is in an obstructed condition, in sufficient quantity to substantially fill the cavity 416 when the switchable window unit is in a transparent condition. A second housing 448 may be coupled to the bottom of existing window 390, for enclosing an optional reservoir 450. The optional reservoir 450 may be connected via tubing 452 to a fitting 454 provided as an outlet port, which may be coupled to a second, optional manifold 419 adhered at the bottom of the existing window 390, in a manner similar to the manifold 418 at the top of the existing window 390.

In operation, the vacuum pump 422 may draw air or other gasses from the cavity 416, introducing a pressure imbalance between the cavity 416 and the atmosphere outside the film 412, thereby causing the index-matching fluid 413 to rise from a reservoir into the cavity 416. Atmospheric pressure exerted on the film 412 forces the flexible film 412 against the existing window 390, further. The index-matching fluid comes into contact with a surface of the lens film 412, which has been drawn by suction closer to the exterior pane of existing window 390. When the level of the index-matching fluid 413 reaches the top of the cavity 416, the existing window 390 with retrofit kit 410 installed becomes transparent in the portion of the lens film 412 in contact with the liquid 413. The lens film 412 and cavity 416 may be configured so that the entire viewable area of the existing window 390 appears transparent. The vacuum pump 422 may operate in an opposite direction to force air or other gasses into the cavity 416, thereby reducing the vacuum level and suction effect upon lens film 412 and index-matching fluid 413, such that the level of the index-matching fluid 413 drops to a level at or near the bottom of the lens film 412. When the index-matching fluid 413 has sufficiently uncovered portions of the lens film 412, and the lens film 412 has become separated from the exterior pane of existing window unit 390 due to the pressure of the air or other gasses forced into cavity 416 by vacuum pump 422 operating in the opposite direction, the existing window 390 with retrofit kit 410 installed becomes at least partially obstructed. In a certain configuration, a second, liquid having a lesser density and a different index of refraction, may be used to displace index-matching fluid 413 from within cavity 416 rather than utilizing air or other gasses. The switchable window apparatus 400 may then be placed in an obstructed condition, in which lens film 412 adjusts light passing through the window apparatus 400 according to the optical characteristics of the inwardly facing surface of the lens film, and a transparent condition, in which lens film 412 in contact with an appropriate index-matching fluid has no noticeable effect upon light passing through the window apparatus 400.

### Second Retrofit Kit Configuration

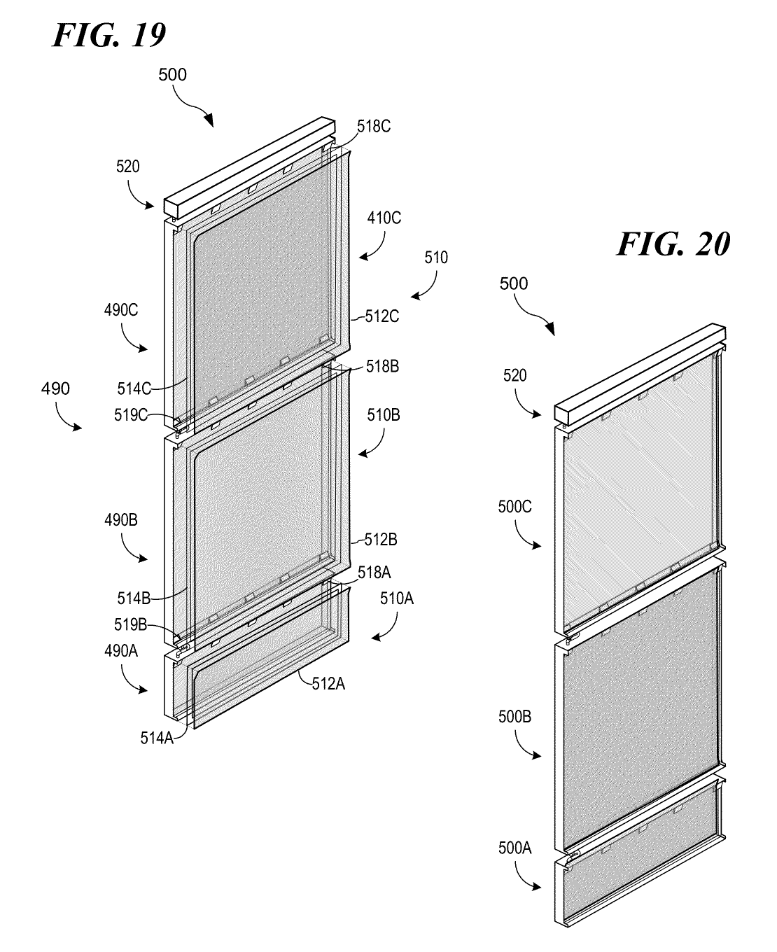

Turning now to FIGS. 19-20, a switchable window apparatus 500 may be formed by installing a retrofit kit 510 upon an existing window assembly 490, wherein the window assembly 490 may have multiple window sections 490A, 490B, and 490C, for example. The retrofit kit may have multiple portions 510A, 510B, and 510C, together with a control assembly 520. Each of the retrofit portions 510A, 510B, and 510C may be similar to the retrofit kit 410 as shown in FIG. 16-18, and may be installed in the same way, adhering a lens film 512 to an exterior pane of an existing window unit 390 using an adhesive 514, including an upper manifold 518, and in certain sections also including a lower manifold 519. Retrofit portion 510A, installed over lower window section 490A, may have only an upper manifold 518A for connecting to the middle window section 490B and retrofit portion 510B. Each retrofit portion 510B and 510C may have an upper manifold 518B, 518C and a lower manifold 519B, 519C for connecting middle window section 490B and retrofit portion 510B to lower window section 490A and retrofit portion 510A, and for connecting the middle window section 490B and retrofit portion 510B to the upper window section 490C and retrofit portion 510C, and for connecting the upper window section 490C and retrofit portion 510C to control assembly 520, respectively.

Control assembly 520 may be similar to control assembly 420 shown in FIG. 16-18, for drawing a vacuum in the cavities of the retrofit window units, drawing index-matching fluid into the cavities, and thereby placing the switchable window apparatus 500 in a transparent mode. The control assembly 520 may also operate in reverse to reduce the vacuum in the cavities of the retrofit window units, allowing the index-matching fluid to recede into a reservoir portion in lower window section 490A and retrofit portion 510A, thereby placing the switchable window apparatus 500 in an obstructed mode.

As shown in FIG. 20, the switchable window apparatus 500 may be composed of multiple switchable window sections 500A, 500B, and 500C, which are interconnected in series with each other and with control assembly 520.

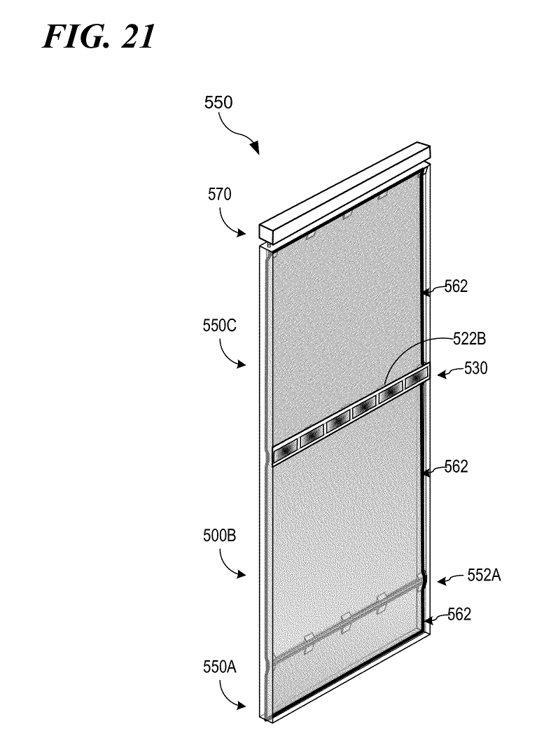

As an alternative to typical AC electric wiring, FIG. 21 depicts a switchable apparatus 550 similar to switchable apparatus 500, but having a photo-voltaic module 530 that may be mounted on the exterior of the apparatus 550, in a space between two of the switchable window sections, for example, between sections 530B and 530C. The photo-voltaic module 530 may be connected to the control assembly 520 by any suitable electrical conduction means, including transparent conductor materials, for providing power to the control assembly 570. The control assembly 570 may contain any suitable electronic power conversation and/or storage means capable of driving a pump within the control assembly 570. For example, a rechargeable battery (not shown) may power the control assembly 570 electronics and pump, and photo-voltaic module 530 may recharge the battery.

The switchable window apparatus 550 of FIG. 21 may include a lower section 550A, a middle section 550B, and an upper section 550C. A control assembly 570 may be coupled to the top of switchable window apparatus 550, and may be similar in construction, purpose and use to that of control assembly 520 (FIGS. 19-20). A single piece of lens film 562 may be applied over the entire window, including sections 550A, 550B, and 550C. Double manifolds 552A, 552B may be used to interconnect the window sections 550A to 550B, and to interconnect the window sections 550B and 550C. A double manifold 552A, 552B may be two manifolds, such as manifold 418 shown in FIG. 18, in which the two manifolds are coupled back-to-back and in fluid communication between them, forming a bridge between sections 550. The respective plenums (440, FIG. 18) may be coupled continuously throughout the length of the double manifold 552, or may be interconnected at one or more ports along the length of the double manifold 552. Note that double manifold 552B may be concealed behind a photo-voltaic module 530 mounted on the exterior of the apparatus 550, in a space between two of the switchable window sections, for example, between sections 550B and 550C. The photo-voltaic module 530 may be connected to the control assembly 570 by any suitable electrical conduction means, including transparent conductor materials, such as indium tin oxide (ITO), for providing power to the control assembly 570. The control assembly 570 may contain any suitable electronic power conversation and/or storage means capable of driving the pump. For example, a rechargeable battery may power the control assembly electronics and pump, and photo-voltaic module 570 may recharge the battery.

### Compressible Lens Configuration

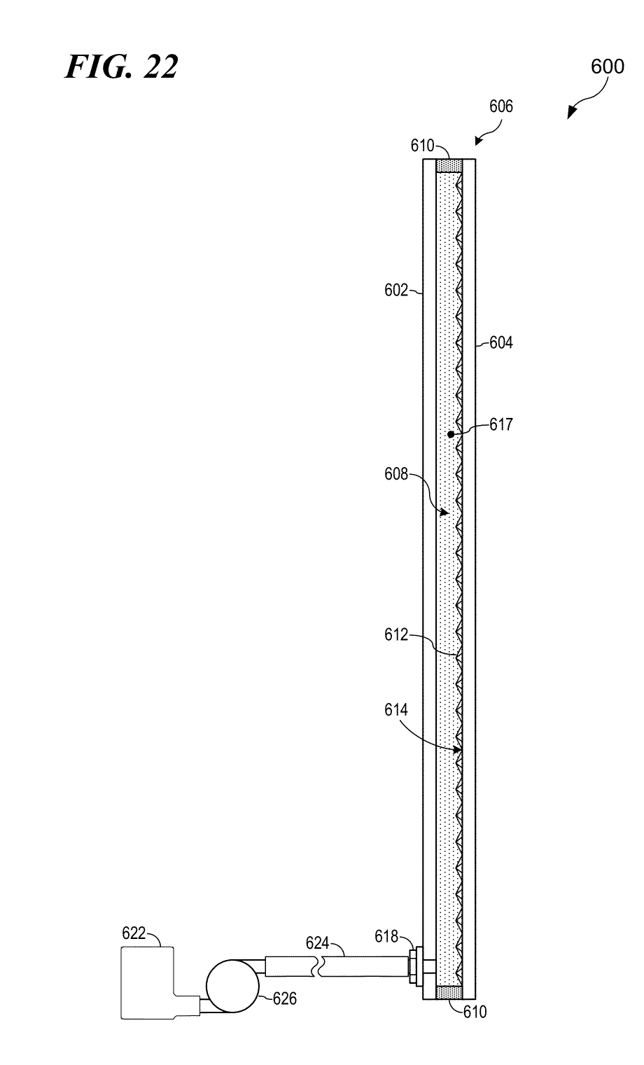

Turning now to FIG. 22, a switchable window apparatus 600 may be used to retrofit existing glazing structures. A substantially rigid, transparent member 602, such as a pane of glass, existing architectural glazing or the like, is coupled to a second, substantially flexible, transparent member 604, such as a polymer film or the like, to form a double-layered structure 606 with an internal cavity 608. The first and second transparent members 602, 604 may be coupled together, and the interior cavity 608 sealed to be gas- and liquid-tight, by any suitable method with any suitable material 610, such as ultrasonic welding, adhesive and the like. The interior face of the outer transparent member 604 includes a lens layer 612 comprised of a transparent material with a known refractive index.

Material comprising the lens layer 612 may be capable of repeated deformations, compressions, or other elastic manipulation without degradation of performance. Materials such as transparent silicone polymers, transparent polyurethanes, or other transparent elastomers are well-suited for this application, but any material that is transparent and elastic may be utilized.

When gas 617 present in the cavity 608 is evacuated through the fitting 618 and conveyed along tubing 624 to a reservoir 622, or vented to the atmosphere, by a pump 626, the pressure differential between the cavity 608 and the atmosphere outside the device 606 will collapse the cavity 608, causing the outer transparent member 604 to approach the inner transparent member 602. As the lens layer 612 contacts the inner transparent member 602, the compressive force exerted by the atmosphere will cause the lens features 614 to elastically deform, conforming to the inner face of the inner transparent member 602. The inner face of the inner transparent member 602 is substantially flat, such that when the lens layer 612 is conformed and in contact with the transparent member 602, light may pass through the switchable window apparatus 600 without substantial scattering or distortion, providing an unobstructed view through the switchable window apparatus 600.

The switchable window apparatus 600, however, may be put into a second state where the view becomes obstructed by reversing the process above. Gas 617 is pumped from a reservoir 622 via a pump 626 through tubing 624 and a fitting 618 into the cavity 608. When the gas 617 present in the cavity 608 reaches an internal pressure nearly equal to or in excess of atmospheric pressure, the outer transparent member 604 will no longer be compressed into contact with the inner transparent member 602, nor will a compressive force exist on the lens layer 612. The features present on the lens layer 612 will return to their original, undistorted shape and act to scatter, diffuse, or otherwise alter light passing through the outer transparent member 604.

### Moveable Lens Configuration

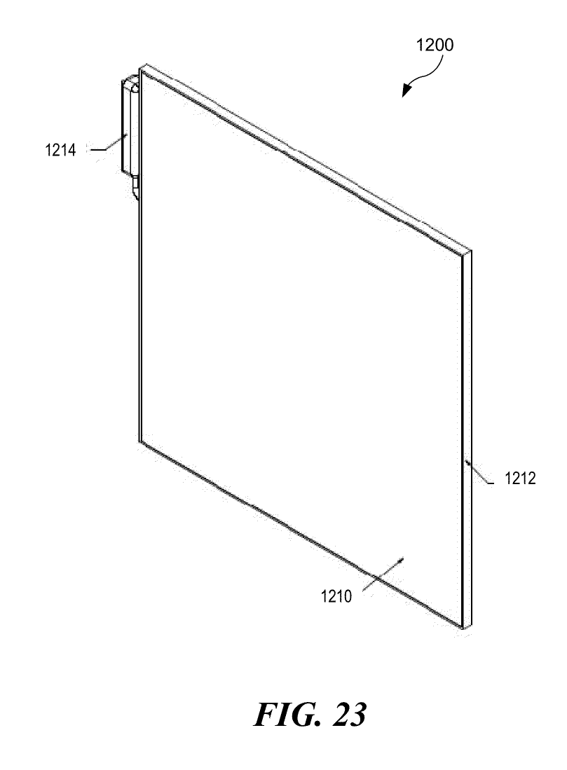

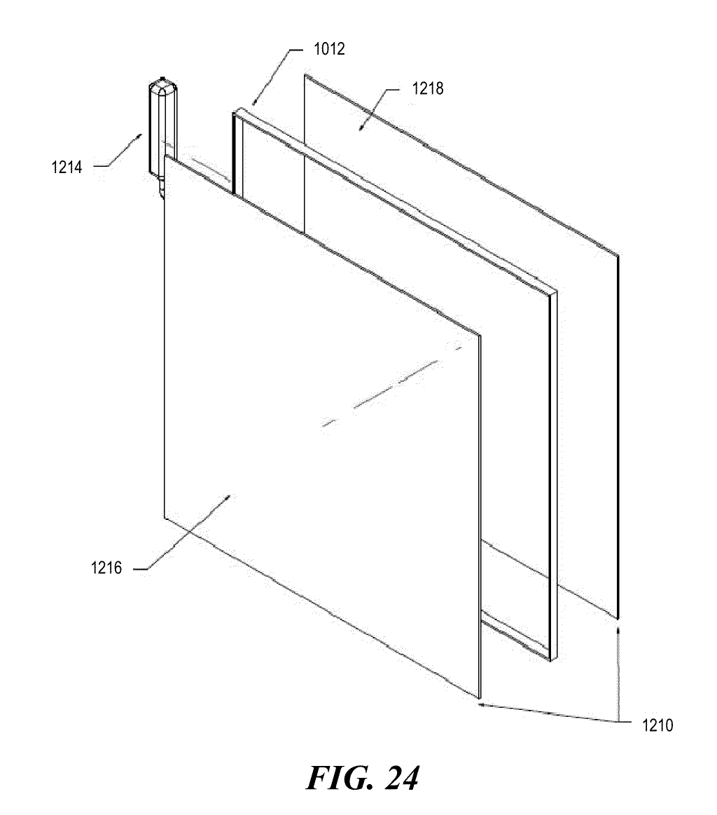

Turning now to FIGS. 23 and 24, a switchable window apparatus 1200 in an assembled view and an exploded view, respectively. The switchable window apparatus 1200 consists of a pair of congruent and parallel lenses 12101210, a framework 1210 surrounding and aligning the lenses, and a housing 1214 external to the lenses. The framework 1212 may be deformable to allow movement of the lenses toward each other to vary the distance between the lenses and to place the inwardly facing surfaces together in nesting contact if desired. Alternatively, the framework 1212 may be rigid and mount one or both of the lenses 1210 to slide toward and away from the other, to vary the distance between the lenses 1210 and to place the inwardly facing lens surfaces together in nesting contact if desired. The framework 1212 also serves as a seal to prevent ingress of gases or liquids into the inter-lens space. The auxiliary housing 1214 is designed to be inconspicuous and may contain components that control the lens position, communication equipment, and power supplies or interfaces. A miniature pump within the housing 1214 may pressurize or evacuate the space between the lens pair 1210 (though the pressure or vacuum may need not be more than a few kPa). If the pump supplies a pressurized gas to the inter-lens cavity, the gap between the lens pair will expand and the device will be in the non-transparent state. Conversely, evacuating the inter-lens cavity will lower the pressure of the space between the lenses 1210 relative to the atmosphere outside the device. This pressure differential will compress the two lenses together, resulting in the device acting as a transparent lens without noticeable image distortion.

Various methods and mechanisms may accomplish the motions required for lens mating and separation. For example, this could be achieved pneumatically as described above, manually, with the aid of electric actuators, piezoelectric actuators, stepper or servo motors, magnetically, and even passively by relying on the thermal expansion properties of the framework 912 material. The methods and mechanisms for physically repositioning two lenses disclosed here may also apply to single-lens configurations, and is not intended to be exhaustive.

The lenses 1210 are a matched pair. Each lens 1210 may have an exterior face 1216 (only one shown) that is flat and smooth, similar to the outer surfaces found on windows or architectural glazing. Various configurations are possible to provide the functionality of traditional glazing or to be deployed in conjunction with traditional window glazing materials and constructions. If the switchable window apparatus is intended to be installed in conjunction with a traditional window system, the lenses may be sized and configured to be aesthetically pleasing. Furthermore, various configurations of switchable window apparatus are possible that are free-standing or having one lens mounted to the traditional architectural glazing.

Instead, the inner faces of the lenses 1210 feature small shapes that protrude normal to the plane of the interior face or small indentations that cut into the lens face. Though it is not necessary or intended to limit the scope of this invention, since the lenses 1210 need not be congruent concave and convex lenses, a variety of corresponding male and female lenses can be used, depending on the effect desired on light transmitted (in either or both inbound and outbound directions) by the glass, in a certain configuration one lens in the pair typically may have only protruding features while the other lens in the pair may have only indentations. This protruding lens is referred to as a “male lens” and the lens with indentations is referred to as a “female lens”. The surface features present on inward-facing surfaces 1218 are much smaller than the lens. For example, a typical architectural glazing panel may be one meter wide and two meters tall. The lenses 1210 are identical in size (i.e., height and width) to each other. The surface features present on the inner lens surfaces 12181218, however, are typically much smaller; these shapes ideally protrude or recede by less than one centimeter. The surface features are not shown in FIG. 23 or FIG. 24 because the fine detail would not be shown with clarity.

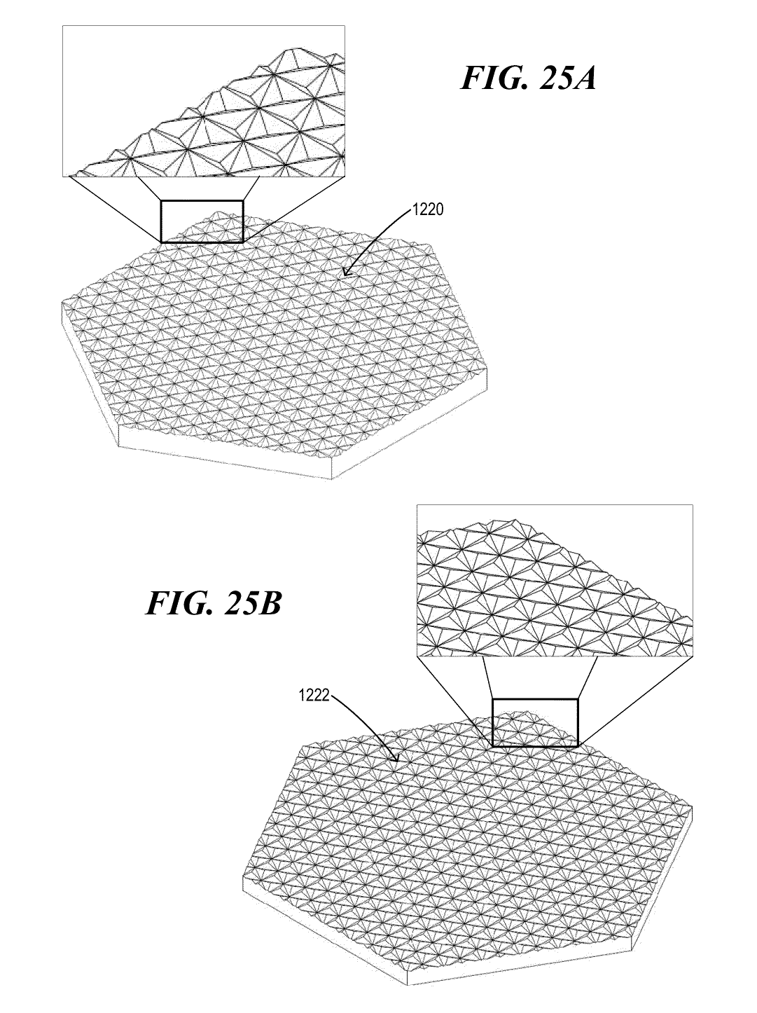

FIGS. 25A, 25B and 26 show examples of surface features that may be utilized for the inner lens surfaces 1218. FIGS. 25A and B depict two segments of a lens pair that utilize an array of pyramids 1220 on the male lens (FIG. 25B) and a complementary array of indentations 1222 on the inner face of the female lens (FIG. 25A). Inset drawings in FIGS. 25A and B provide a higher degree of detail of the inner surfaces 1218. The pyramids have bases comprised of equilateral triangles and an included angle of 120 degrees between two faces of adjacent pyramids. FIG. 26, similarly, provides a detailed view of the inner lens face 1218, with an exemplary alternative surface 1218 profile. Instead of the array of pyramids 1220, an array of ridges 1230 is utilized. Lenses that have a repeating, linear surface feature, such as that shown in FIG. 26, have the added convenience that a single lens shape can serve as both the male and female lens by simply rotating one lens 180 degrees. The geometries shown in FIGS. 25A and B and FIG. 26 are not intended to be exhaustive. Rather, it is expected that the feature geometries and dimensions would be selected such that the lenses be suited for the given parameters (e.g., expected range of light wavelengths, expected angles of incidence, materials, desired light adjustment, and the like).

The device 1200 manipulates incident light by employing an outer lens 1210 (the lens upon which light first contacts) that is relatively flat and smooth, while the inner face of the lens is non-planar. When the male lens is not in contact with its complementary lens, incident light passing through the lens will travel through a materials interface of two materials with different indices of refraction. For example the light ray could travel from an acrylic lens with n_{D}=1.49 into a cavity between the lenses containing air with n_{D}=1.00. This light ray will not travel in a straight line, but will refract at the material interface. The direction that the light travels as it passes from one material to another is a function of the angle of incidence (controlled by surface geometry) and the index of refraction of the materials.

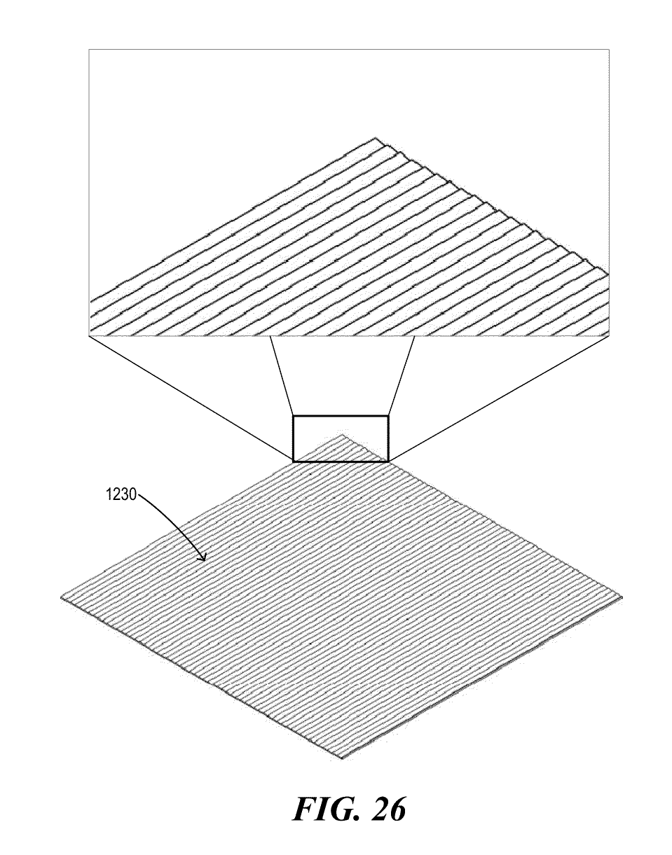

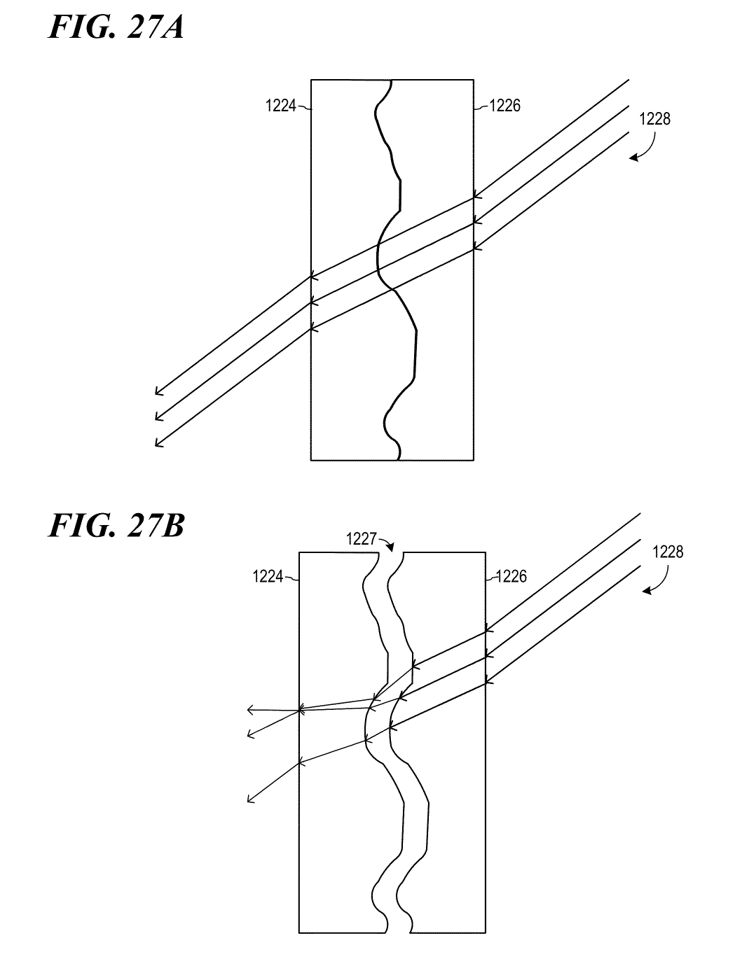

FIGS. 27A and B depict, respectively, two cross section views of a first lens 1224 and a second lens 1226 having corresponding inwardly facing, mating surfaces in intimate contact (i.e., no appreciable gap between mating surfaces in intimate contact) and when this lens pair is positioned with a small gap between the inwardly facing surfaces of lenses 1224 and 12261226. Incident rays of light 1228 will travel through the lenses 1224 and 1226 in both configurations. When the lenses 1224 and 1226 are intimately mated, parallel rays of light contacting the outer surface of lens 1226 will also exit through the outer face of mating lens 1224 in parallel. An observer looking through the lenses in this configuration would see an undistorted image and the two lenses 1224, 1224, 1226 would appear transparent.

When a gap 1227 is formed between the same lens pair, as depicted in FIG. 27B, the parallel rays of light 1228 no longer travels through the lenses 1224, 1224, 1226 along parallel paths. The light rays pass through the outer lens 1226 in the same manner as when the lenses 1224, 1224, 1226 are mated. The ray paths, however, diffuse when they encounter the material interface between the outer lens 1226 and the inter-lens gap 1227. The direction the light rays take at this interface is a function of the orientation of the light ray (or angle of incidence) to the inner surface of the lens 1226. In this example, the inner surface of lens 1226 has a varying (in the example illustrated, randomly varying) orientation; therefore, the angle of incidence for light at the lens/gap interface also varies (in the example illustrated, randomly). The variations in the angle of incidence result in light rays that are refracted in varying, random directions, and possibly even internally reflected if the angle of incidence exceeds the critical angle for the lens/gap interface material combination. An observer looking through the lenses in the separated configuration of FIG. 27B would not see the undistorted image that would be observed when the lenses are in the mated configuration of FIG. 27A.

The characteristics of the observed image, and the manner in which the lens pair manipulates incident light is a function of the lens' surface features. If that surface is wavy, the image would appear distorted. Finely textured surfaces will diffuse light. Faceted shapes, such as ridges or pyramids, will yield a kaleidoscope-like image. Each lens need not contain only one type of feature; accordingly, a combination of features could be deployed.

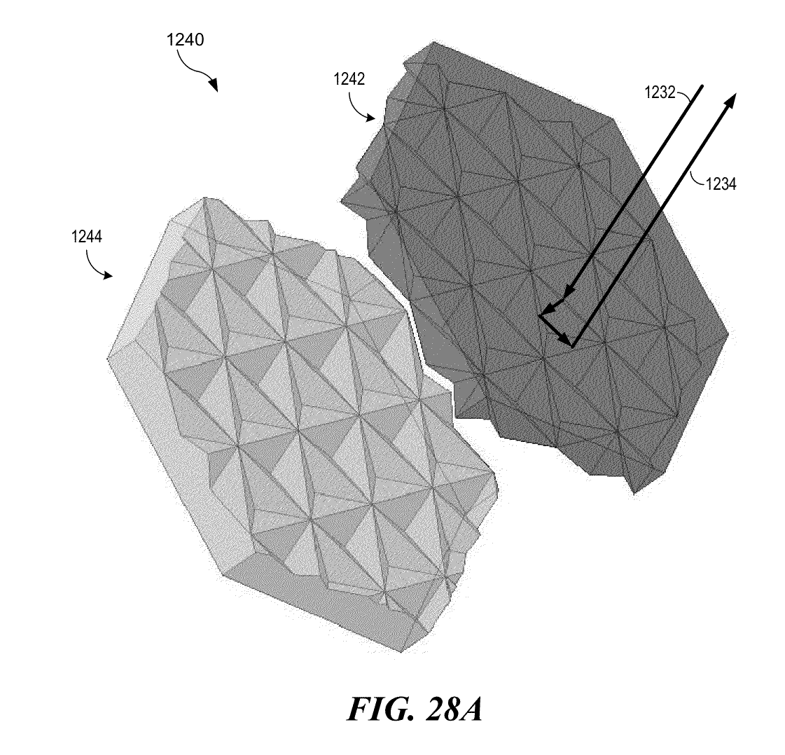

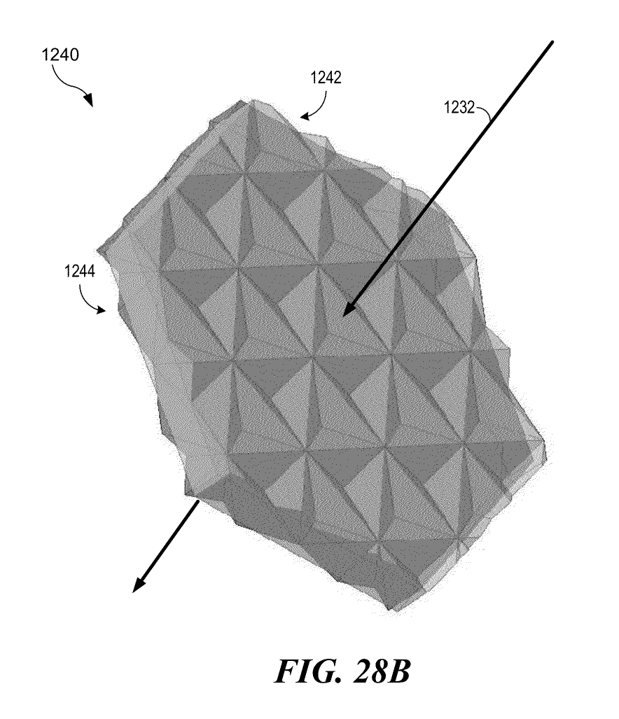

For embodiments of the invention that utilize faceted surfaces (pyramids, ridges, etc.), the orientation of the facets should be selected such that the incident light is not merely refracted, but ideally experiences total internal reflection. One embodiment of the invention that meets the faceted criteria is shown in FIG. 28A and FIG. 28B. FIG. 28A details a small section of a lens pair 1240 having a male lens 1242 and female lens 1244 in the separated state. When the incident light ray 1232 travels through the male lens 1242, the light encounters the material interface at an angle greater than the critical angle. The light ray is totally internally reflected each time it encounters the lens/gap interface (each facet). This internal reflection occurs multiple times, resulting in a light ray 1234 that exits the lens 1242 in the direction of the incident light. This feature is particularly useful to manipulate undesirable specular reflection. For example, the glass façade of a high-rise building may reflect sunlight in an inconvenient direction, causing discomfort or a safety hazard within the vicinity of the building. An embodiment of the invention could be fabricated such that when the lens pairs are separated by a small gap, the outer lens acts as a retro reflector and redirects the glare in a safe or convenient direction. The most common source of undesirable glare is the sun, a light source located above the horizon. Sunlight redirected back towards the sun, or merely at an angle above horizontal, is far less likely to be a nuisance than glare than reflects from the sun towards the ground (at an angle below horizontal). As shown in FIG. 28B, the male lens 1242 and the female lens 1244 may be brought closely together, practically in contact with each other such that the gap 1227 (FIG. 27B) is zero, or practically negligible, such that incident light ray 1232 passes through the lens pair 1240 without experiencing significant refractive or reflective effects. The light ray 1232 effectively travels through the lens pair 1240 and exits the lens pair 1240 at substantially the same angle.

### Light Ray Diagrams

A switchable window unit such as hereinbefore described is capable of many variations and configurations. The following light ray diagrams illustrate schematically a number of different configurations and their effects in obstructed conditions and in transparent conditions. In an obstructed condition, light rays entering a switchable window apparatus may be scattered in a non-uniform manner by surfaces of a lens element. Light rays passing through the switchable window apparatus may experience significant redirection, distortion, or scattering. Parallel light rays passing through the switchable window apparatus may no longer be parallel when exiting the switchable window apparatus. In a transparent condition, The optical effect of the lens element may be negated or neutralized such that light rays may pass through the switchable window apparatus without significant redirection, distortion, or scattering. Parallel light rays passing through the switchable window apparatus may still be parallel when exiting the switchable window apparatus.

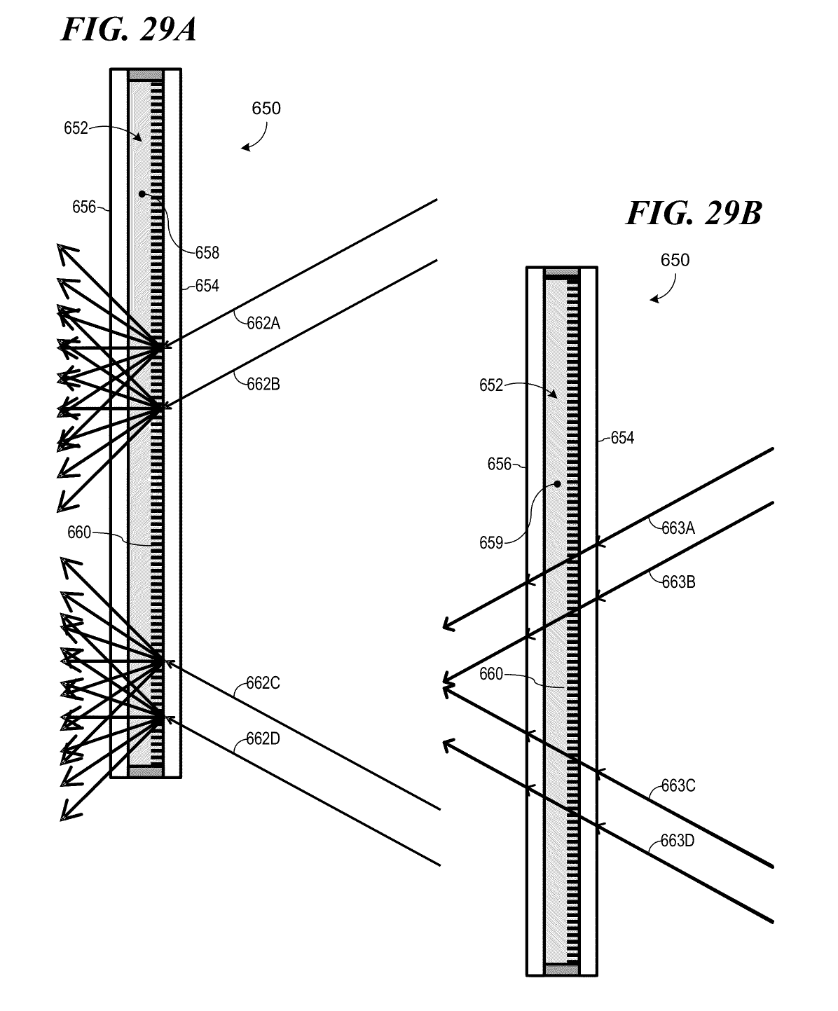

Turning now to FIG. 29A-29B, one effect of a switchable window unit is illustrated in simple light ray diagrams. FIG. 29A illustrates a switchable window apparatus 650, such as may be used as an original or replacement architectural feature and shown for example in FIGS. 12-15, in which a cavity 652 is formed between two transparent substrates 654, 656. In an obstructed condition, the cavity 652 may be substantially filled with a fluid 658 having an index of refraction that does not match an index of refraction of a lens element 660 mounted within the cavity 652, such as air, other gases, or a non-matching liquid. In the obstructed condition, light rays 662A and 662B may be parallel approaching the switchable window apparatus 650. Incident light rays 662C and 662D may also be parallel approaching the switchable window apparatus 650. Light rays 662A-662B or 662C-662D and entering the switchable window apparatus striking the outer surface of the first transparent substrate 654 may pass through the transparent substrate 654 without significant distortion, redirection or scattering. The light rays 662A-662B or 662C-662D may be may be scattered in a non-uniform manner by surfaces of the lens element 660, and may pass through the second transparent substrate 656 without significant further effect. Light rays passing through the switchable window apparatus 650 may experience significant redirection or scattering. Parallel light rays passing through the switchable window apparatus 650 may no longer be parallel when exiting the switchable window apparatus 650.

In a transparent condition shown in FIG. 29B, the cavity 652 may be substantially filled with a fluid 659 having an index of refraction that matches an index of refraction of the lens element 660 mounted within the cavity 652, such as an index-matching liquid as hereinbefore described. In the transparent condition, light rays 663A-663B or 663C-663D striking the outer surface of the first transparent substrate 654 may pass through the transparent substrate 654 without significant distortion, redirection or scattering. The light rays 663A-663B may refract slightly at the interface between the second transparent substrate 656 and air. The light ray or 663C-663D may travel through the lens element 600 and the index-matching fluid 659 without noticeable effect since the indices of refraction of the transparent the lens element 660 and the index-matching fluid 659 may be substantially equal. The angle of incidence of the light ray entering the switchable window apparatus 650 may be substantially equal to the angle of refraction of the light ray exiting the switchable window apparatus 650. Light rays may pass through the switchable window apparatus 650 without significant redirection or scattering. Parallel light rays passing through the switchable window apparatus 670 may still be parallel when exiting the switchable window apparatus 670.

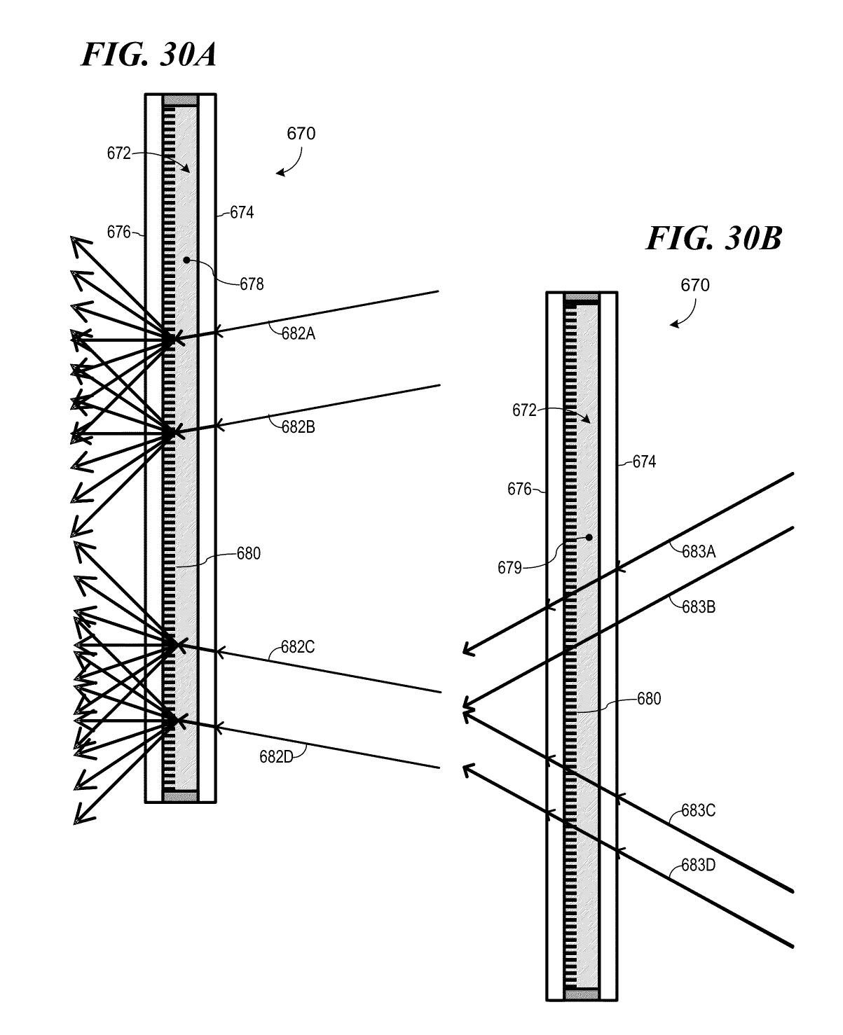

Turning now to FIG. 30A-30B, a switchable window apparatus 670 may have a cavity 672 formed between a first transparent substrate 674 and a second transparent substrate 676. A lens element 680 may be mounted within the cavity 672, supported on an interior surface of the second transparent substrate 676. The cavity 672 may be substantially filled with a non-matching fluid 678, such as air for example, or an index-matching fluid 679 such as hereinbefore described. In an obstructed condition shown in FIG. 30A, the cavity 672 may be substantially filled with the non-matching fluid 678. Incident light rays 682A and 682B may be parallel approaching the switch able window apparatus 670. Incident light rays 682A-682B or 682C-682D may also be parallel approaching the switchable window apparatus 670 and may refract slightly at the outer surface of the first transparent substrate 674. The light rays 682A-682B or 682C-682D may be scattered in a non-uniform manner by surfaces of the lens element 680, and a light rays 682A-682B or 682C-682D may pass through the second transparent substrate 676 without significant distortion, redirection or scattering. Light rays passing through the switchable window apparatus 670 may experience significant redirection or scattering. Parallel light rays passing through the switchable window apparatus 670 may no longer be parallel when exiting the switchable window apparatus 670.

In a transparent condition shown in FIG. 30B, the cavity 672 may be substantially filled with a fluid 679 having an index of refraction that matches an index of refraction of the lens element 680 mounted within the cavity 672, such as an index-matching liquid as hereinbefore described. In the transparent condition, a light rays 682A-682B or 682C-682D striking the outer surface of the first transparent substrate 674 may pass through the first transparent substrate 674 without significant distortion, redirection or scattering. The light rays 682A-682B or 682C-682D may travel through the lens element 680 and the index-matching fluid 679 without noticeable effect since the indices of refraction of the transparent the lens element 680 and the index-matching fluid 669 may be substantially equal. The light rays 682A-682B or 682C-682D may pass through the second transparent substrate 676 without significant distortion, redirection or scattering. The angle of incidence of the light ray entering the switchable window apparatus 670 may be substantially equal to the angle of refraction of the light ray exiting the switchable window apparatus 670. Light rays may pass through the switchable window apparatus 670 without significant redirection or scattering. Parallel light rays passing through the switchable window apparatus 670 may still be parallel when exiting the switchable window apparatus 670.

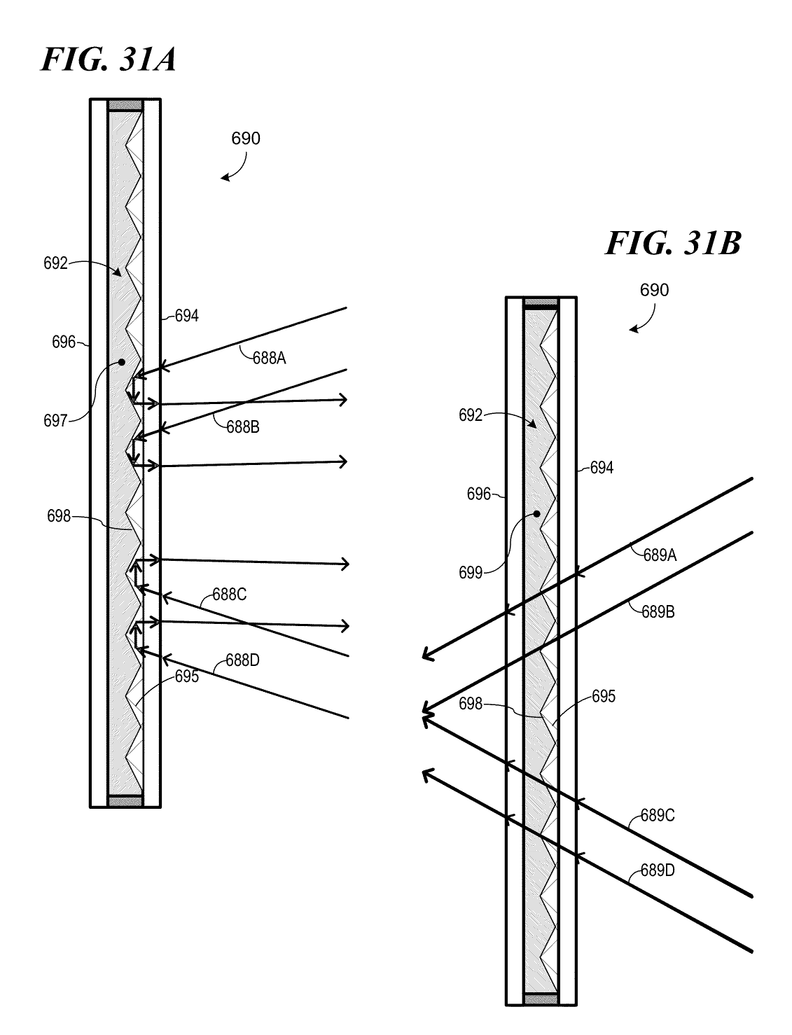

Turning now to FIG. 31A-31B, a switchable window apparatus 690 may have a cavity 692 formed between a first transparent substrate 694 and a second transparent substrate 696. A lens element 698 may be mounted within the cavity 692, supported on an interior surface of the first transparent substrate 694. The lens element 698 may be an array of prismatic lenses, having many facets 695, arranged as a retro-reflector. The cavity 692 may be substantially filled with a non-matching fluid 697, such as air for example, or an index-matching fluid 699 such as hereinbefore described. In an obstructed condition shown in FIG. 31A, the cavity 692 may be substantially filled with the non-matching fluid 697, and light rays 662A-662B or 662C-662D are scattered in a non-uniform manner by surfaces of the lens element 698. Because of the specific orientation of the many facets of the retro-reflective lens element 698, incident light, such as light rays 662A-662B or 662C-662D may be parallel approaching the switchable window apparatus 650, and may experience total internal reflection encountering a material interface going from a higher to lower refractive index, such as passing through the polymer lens element 698 into the non-matching fluid 697, such as air for example. The retro-reflective lens element 698 may reduce transmission through the lens element 698 because the retro-reflective lenses may not scatter light, but may reduce, in some cases completely, the quantity of light passing through the lens element 698. The light may be redirected in a non-uniform manner by the facets 695 of lens element 698, and may return through the first transparent substrate 694. Light rays passing through the switchable window apparatus 690 may experience significant redirection or scattering. Parallel light rays passing through the switchable window apparatus 690 may no longer be parallel when exiting the switchable window apparatus 690.

In a transparent condition shown in FIG. 31B, the cavity 692 may be substantially filled with index-matching fluid 699. Light rays 688A-688B or 688C-688D striking the outer surface of the first transparent substrate 674 may refract slightly at the interface between air and glass (for example). The light rays 688A-688B or 688C-688D may travel through the lens element 698 and the index-matching fluid 699 without noticeable effect since the indices of refraction of the transparent the lens element 698 and the index-matching fluid 699 may be substantially equal. The light rays 688A-688B or 688C-688D may pass through the second transparent substrate 696 without significant distortion, redirection or scattering. The angle of incidence of the light ray entering the switchable window apparatus 690 may be substantially equal to the angle of refraction of the light ray exiting the switchable window apparatus 690. Light rays may pass through the switchable window apparatus 690 without significant redirection or scattering. Parallel light rays passing through the switchable window apparatus 690 may still be parallel when exiting the switchable window apparatus 690.

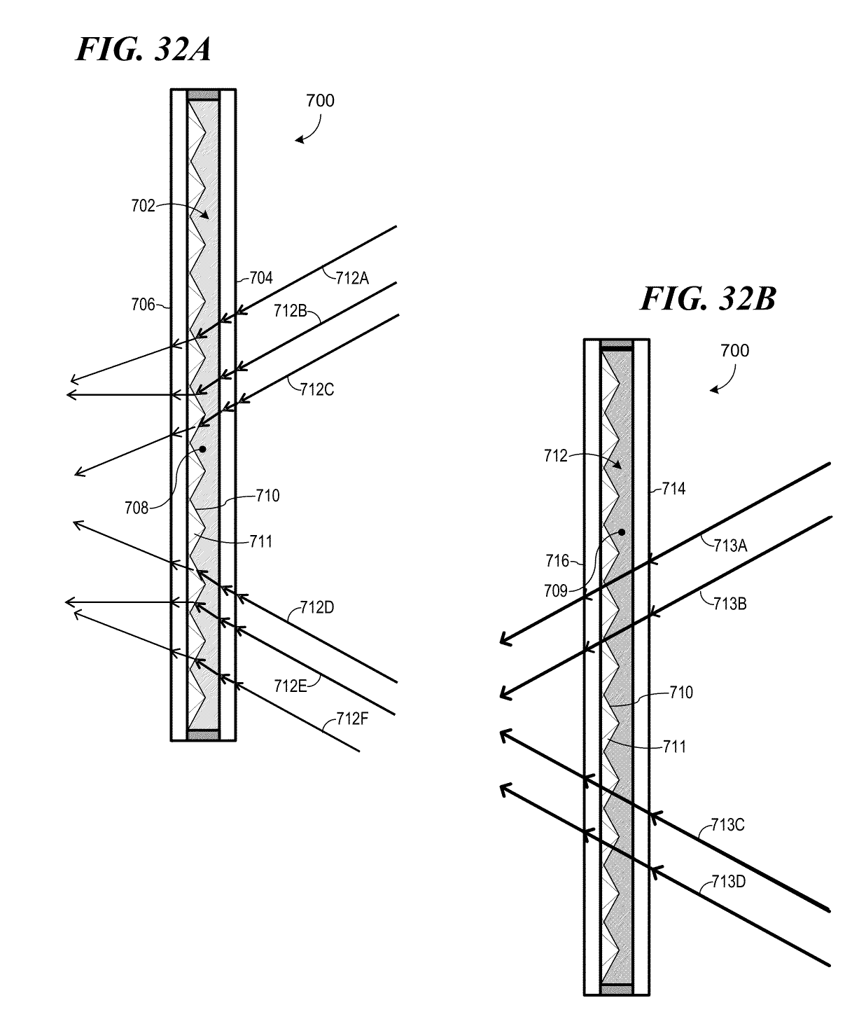

Turning now to FIG. 32A-32B, a switchable window apparatus 700 may have a cavity 702 formed between a first transparent substrate 704 and a second transparent substrate 706. A lens element 710 may be mounted within the cavity 702, supported on an interior surface of the second transparent substrate 706. The lens element 710 may be an array of prismatic lenses, having many facets 711. The cavity 702 may be substantially filled with a non-matching fluid 708, such as air for example, or an index-matching fluid 709 such as hereinbefore described. In an obstructed condition shown in FIG. 32A, the cavity 702 may be substantially filled with the non-matching fluid 708, and parallel light rays 712A-712C or 712D-712F may be scattered in a non-uniform manner by surfaces of the lens element 698. Because of the specific orientation of the many facets of the lens element 698, incident light, such as light rays 712A-712C or 712D-712F, may experience refraction or distortion passing through the non-matching fluid 708, such as air for example, into polymer lens element 710. The light may be redirected in a non-uniform manner by the facets 711 of lens element 710, and may pass through the second transparent substrate 706. Light rays passing through the switchable window apparatus 700 may experience significant redirection or scattering. Parallel light rays passing through the switchable window apparatus 700 may no longer be parallel when exiting the switchable window apparatus 700.

In a transparent condition shown in FIG. 32B, the cavity 702 may be substantially filled with index-matching fluid 709. A light ray 713A or 713B striking the outer surface of the first transparent substrate 704 may pass through the first transparent substrate 704 without significant distortion, redirection or scattering. The light ray 713A or 713B may travel through the index-matching fluid 709 and the lens element 710 without noticeable effect since the indices of refraction of the lens element 710 and the index-matching fluid 709 may be substantially equal. The parallel light rays 713A-713B or 713C-713D may pass through the second transparent substrate 716 without significant distortion, redirection or scattering. The angle of incidence of the light ray entering the switchable window apparatus 700 may be substantially equal to the angle of refraction of the light ray exiting the switchable window apparatus 700. Light rays may pass through the switchable window apparatus 700 without significant redirection or scattering. Parallel light rays passing through the switchable window apparatus 700 may still be parallel when exiting the switchable window apparatus 700.

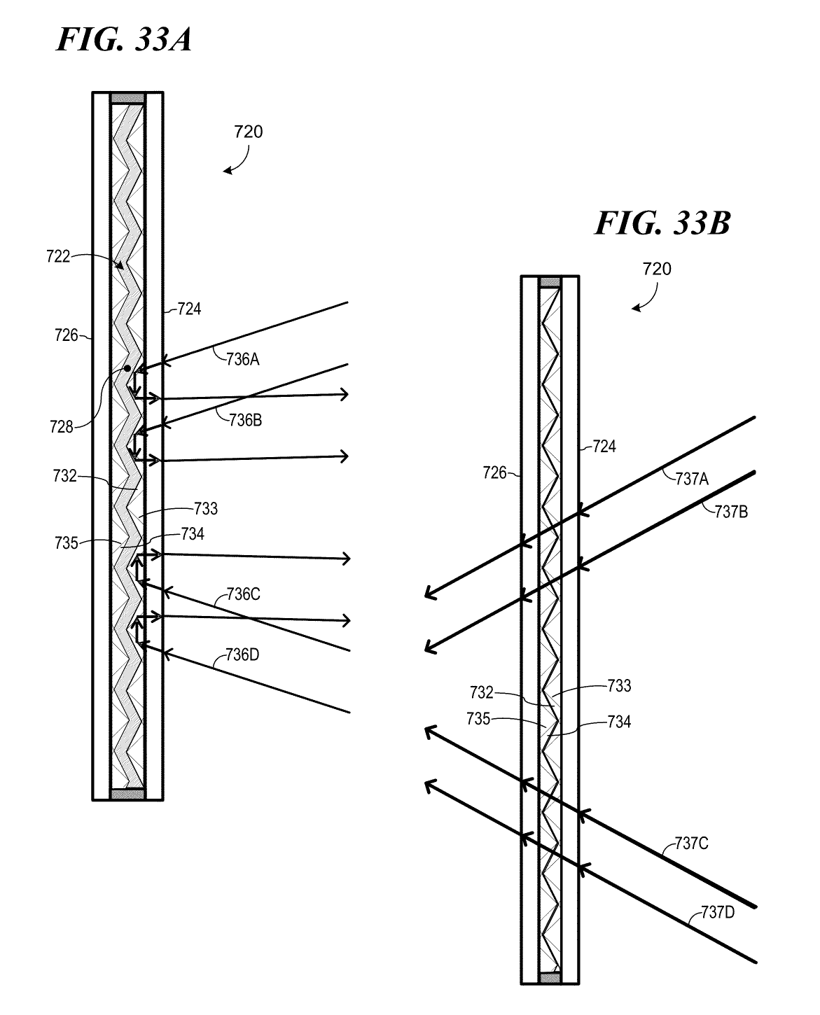

Turning now to FIG. 33A-33B, a switchable window apparatus 720 may have a cavity 722 formed between a first transparent substrate 724 and a second transparent substrate 726. A first lens element 732 may be mounted within the cavity 722, supported on an interior surface of the first transparent substrate 724. A second lens element 734 may be mounted within the cavity 722, supported on an interior surface of the second transparent substrate 724. The first lens element 732 may be an array of prismatic lenses, having many facets 733. The second lens element 734 may be an array of prismatic lenses, having many facets 735, and may be complementary to first lens element 732. The cavity 722 may be substantially filled with a non-matching fluid 728, such as air for example, and need not be sealed. In an obstructed condition shown in FIG. 33A, the cavity 722 may be substantially filled with the non-matching fluid 728, and need not be sealed. The first and second transparent substrates 724, 726 may be separated by some distance such that first and second lens elements 732, 734 are not in contact with each other. Parallel light rays 736A-736B or 736C-736D may be scattered in a non-uniform manner by surfaces of the first lens element 732. Because of the specific orientation of the many facets 733 of the retro-reflective lens element 732, incident light, such as light rays 736A-736B or 736C-736D, may experience total internal reflection encountering a material interface going from a higher to lower refractive index, such as passing through the polymer lens element 732 into the non-matching fluid 729, such as air for example. The retro-reflective lens element 732 may reduce transmission through the lens element 732 because the retro-reflective lenses may not scatter light, but may reduce, in some cases completely, the quantity of light passing through the lens element 732. The light may be redirected in a non-uniform manner by the facets 733 of lens element 732, and returns through the first transparent substrate 724. Light rays passing through the switchable window apparatus 720 may experience significant redirection or scattering. Parallel light rays passing through the switchable window apparatus 720 may no longer be parallel when exiting the switchable window apparatus 720.

In a transparent condition shown in FIG. 33B, the first transparent substrate 724 and the second transparent substrate 726 are brought close together such that first and second lens elements 732, 734 may be in substantial contact with each other. The cavity 722 may be compressed until there is no longer a cavity between the first and second lens elements 732, 734. Parallel light rays 737A and 737B striking the outer surface of the first transparent substrate 724 may pass through the first transparent substrate 724 without significant distortion, redirection or scattering. The light rays 737A and 737B may travel through the first lens element 732 and the second lens element 734 without noticeable effect since the indices of refraction of the first and second lens elements 732, 734 may be substantially equal. The light rays 737A and 737B may pass through the second transparent substrate 726 without significant distortion, redirection or scattering. The angle of incidence of the light ray entering the switchable window apparatus 720 may be substantially equal to the angle of refraction of the light ray exiting the switchable window apparatus 720. Light rays may pass through the switchable window apparatus 720 without significant redirection or scattering. Parallel light rays passing through the switchable window apparatus 720 may still be parallel when exiting the switchable window apparatus 720.

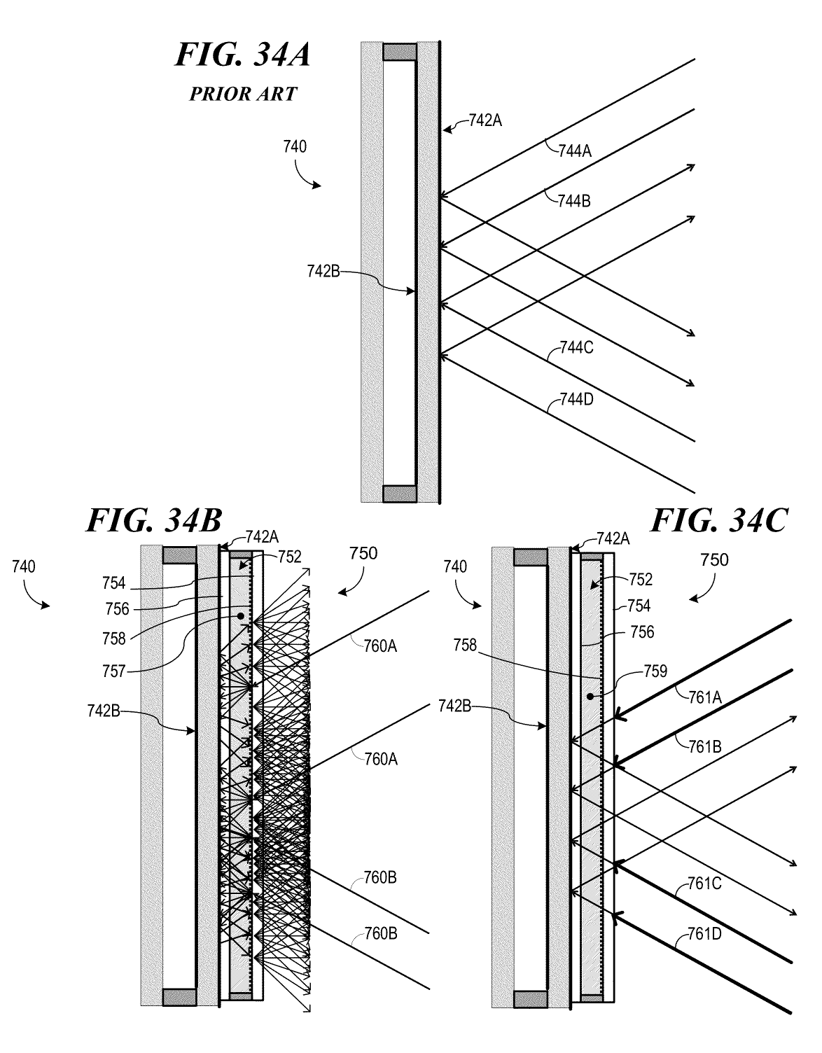

Turning now to FIG. 34A-34C, one effect of a switchable window apparatus 750 is illustrated in simple light ray diagrams. FIG. 34A illustrates a typical double-paned architectural window unit 740 having reflective glazing 742A on an exterior surface. Alternatively, the window unit 740 may have a reflective glazing 742B on an interior surface instead of or in addition to reflective glazing 742A on an exterior surface. Parallel light rays 744A-744B or 744C-744D striking the reflective glazing 742A may reflect at an angle corresponding to the angle of incidence of the light ray 744A or 744B upon the glazing 742A. Incident light striking the glazing 742A may display specular reflection or glare, which is not aesthetically pleasing. FIG. 34B illustrates the switchable window apparatus 750 comprising a retro-fit kit installed over an existing window unit having reflective glazing, such as shown in FIGS. 16-21, on an exterior side of the existing window 740. In an obstructed condition shown in FIG. 34B, a sealed cavity 752 may be formed between a first transparent substrate 754 and a second transparent substrate 756. A lens element 758 may be mounted within the cavity 752, supported on an interior surface of the first transparent substrate 754. The cavity 752 may be substantially filled with a non-matching fluid 757, such as air for example. The fluid 752 in contact with lens element 758 may be a poor match for the refractive index of the lens material, having a substantially different index of refraction than that of the lens element 758. Parallel light rays 760A-760B or 760C-760D striking the lens element 758 may be scattered or refracted at various different angles depending upon the location and angle of incidence of each light ray 760A-760B or 760C-760D upon the lens element 758, and the configuration of the effective surface of the lens element 758. A significant portion of light rays 760A-760B or 760C-760D striking the lens element 758 may be diffused, rather than exhibiting specular reflection or glare when reflected from reflective glazing 742A. The light rays 760A-760B or 760C-760D may be refracted at various different angles, again depending upon the location and angle of incidence of each light ray 760A-760B or 760C-760D upon the lens element 758, striking the lens element 758 a second time after reflection from reflective glazing 742A. Light rays passing through the switchable window apparatus 750 may experience significant redirection or scattering. Parallel light rays passing through the switchable window apparatus 750 may no longer be when exiting the switchable window apparatus 750.

In a transparent condition shown in FIG. 34C, the cavity 752 may be substantially filled with an index-matching fluid 759. Light rays 761A-761B or 761C-761D striking the outer surface of the first transparent substrate 754 may pass through the first transparent substrate 754 without significant distortion, redirection or scattering. The light rays 761A-761B or 761C-761D may travel through the lens element 758 and the index-matching fluid 759 without noticeable effect since the indices of refraction of the lens element 758 and the index-matching fluid 759 may be substantially equal. Parallel light rays 761A-761B or 761C-761D may pass through the second transparent substrate 756 and reflect from reflective glazing 742B. The angle of incidence of the light ray entering the switchable window apparatus 750 may be substantially equal to the angle of reflection of the light ray exiting the switchable window apparatus 750. Light rays may pass through the switchable window apparatus 750 without significant distortion or scattering, but may exhibit specular reflection or glare. Parallel light rays passing through the switchable window apparatus 750 are may still be parallel when exiting the switchable window apparatus 750.

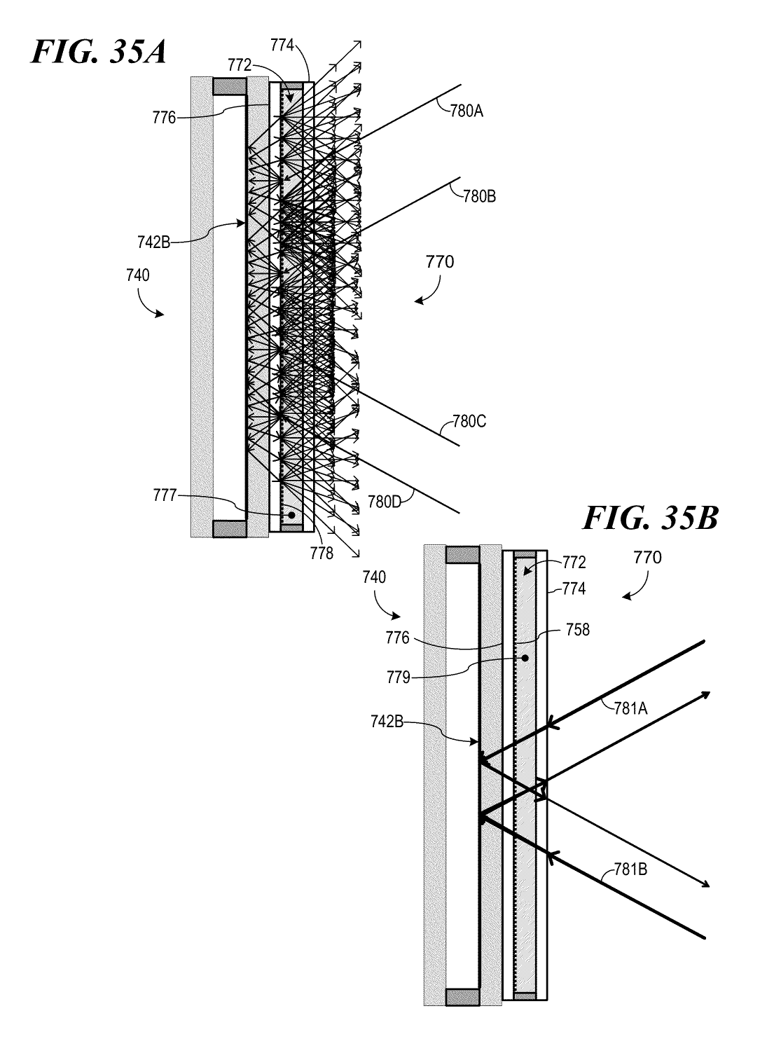

Turning now to FIG. 35A-35B, a switchable window apparatus 770 may comprise a retro-fit kit installed over an existing window unit having reflective glazing, such as shown in FIGS. 16-21, on an exterior side of the existing window 740. In an obstructed condition shown in FIG. 35A, a sealed cavity 772 may be formed between a first transparent substrate 774 and a second transparent substrate 776. A lens element 778 may be mounted within the cavity 772, supported on an interior surface of the second transparent substrate 776. The cavity 772 may be substantially filled with a non-matching fluid 777, such as air for example. The fluid 772 in contact with lens element 778 may be a poor match for the refractive index of the lens material, having a substantially different index of refraction than that of the lens element 778. Light rays 780A-780B or 780C-780D striking the lens element 778 may be refracted at various different angles depending upon the location and angle of incidence of each light of rays 780A-780B or 780C-780D upon the lens element 778, and the configuration of the effective surface of the lens element 778. A significant portion of light rays 780A-780B or 780C-780D striking the lens element 778 may be diffused, rather than exhibiting specular reflection or glare when reflected from reflective glazing 742B. The light rays 780A and 780B may be refracted at various different angles, again depending upon the location and angle of incidence of each light ray 780A-780B or 780C-780D upon the lens element 778, striking the lens element 778 a second time after reflection from reflective glazing 742B. Light rays passing through the switchable window apparatus 770 may experience significant redirection or scattering.

In a transparent condition shown in FIG. 35B, the cavity 772 may be substantially filled with an index-matching fluid 779. A light ray 781A or 781B striking the outer surface of the first transparent substrate 754 may pass through the first transparent substrate 754 without significant distortion, redirection or scattering. The light ray 781A or 781B may travel through the lens element 778 and the index-matching fluid 779 without noticeable effect since the indices of refraction of the lens element 778 and the index-matching fluid 779 may be substantially equal. The light ray 781A or 781B may pass through the second transparent substrate 776 and reflect from reflective glazing 742B. The light ray 781A or 781B may travel through the lens element 778 and the index-matching fluid 779 without noticeable effect since the indices of refraction of the transparent the lens element 778 and the index-matching fluid 779 may be substantially equal. The angle of incidence of the light ray entering the switchable window apparatus 770 may be substantially equal to the angle of reflection of the light ray exiting the switchable window apparatus 770. Light rays may pass through the switchable window apparatus 770 without significant distortion or scattering, but may exhibit specular reflection or glare.

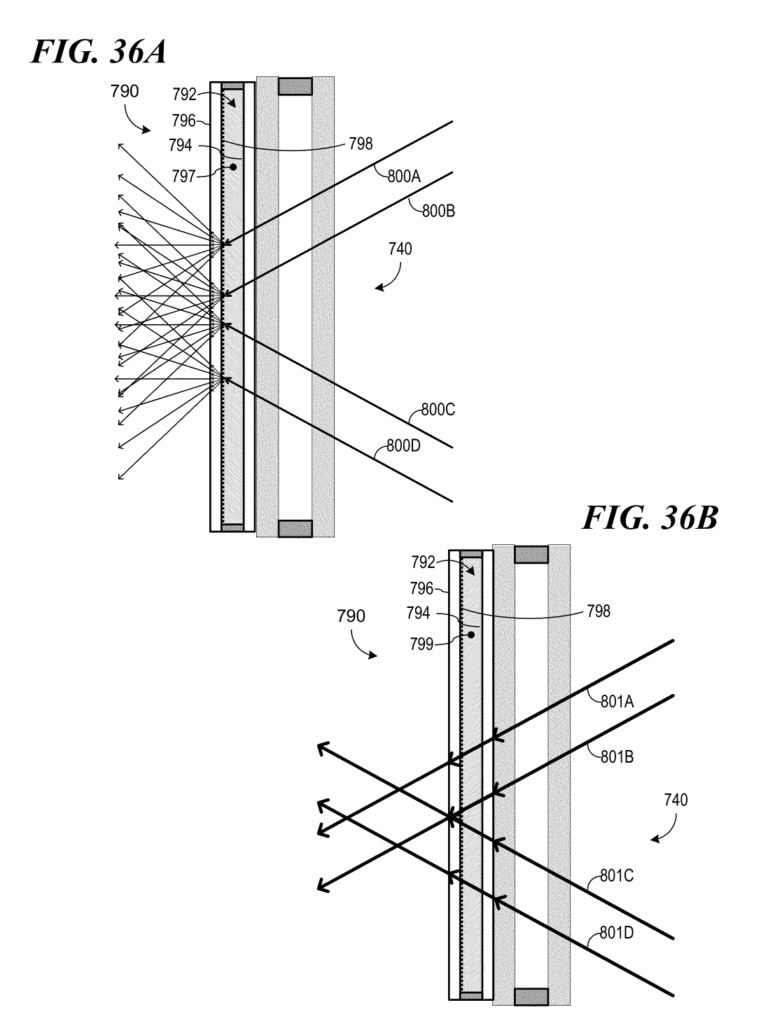

Turning now to FIG. 36A-36B, a switchable window apparatus 790 may comprise a retro-fit kit, such as shown in FIGS. 16-21, on an interior side of the existing window 740, installed over the existing window unit 740, which may not have any reflective glazing, for example. In an obstructed condition shown in FIG. 36A, a sealed cavity 792 may be formed between a first transparent substrate 794 and a second transparent substrate 796. A lens element 798 may be mounted within the cavity 792, supported on an interior surface of the second transparent substrate 796. The cavity 792 may be substantially filled with a non-matching fluid 797, such as air for example. The fluid 797 in contact with lens element 798 may be a poor match for the refractive index of the lens material, having a substantially different index of refraction than that of the lens element 798. Incident light rays 800A-800B or 800C-800D striking the exterior of existing window unit 740 may pass through the existing window unit without significant distortion, redirection or scattering. Light rays 800A and 800B striking the first lens element 798 may be refracted at various different angles depending upon the location and angle of incidence of each light ray 800A-800B or 800C-800D upon the lens element 798, and the configuration of the effective surface of the lens element 798. A significant portion of light rays 800A-800B or 800C-800D striking the lens element 798 may be diffused. Light rays passing through the switchable window apparatus 790 may experience significant redirection or scattering.

In a transparent condition shown in FIG. 36B, the cavity 792 may be substantially filled with an index-matching fluid 799. The fluid 799 in contact with the lens element 798 may be a good match for the refractive index of the lens material, having an index of refraction substantially equal to that of the lens element 798. A light ray 801A-801B or 801C-801D striking the existing window unit 740 may pass through the existing window unit 740 without significant distortion, redirection or scattering, and may pass through the lens element 798 and the index-matching fluid 799 without noticeable effect since the indices of refraction of the lens element 798 and the fluid 799 may be substantially equal. Light rays may pass through the switchable window apparatus 790 without significant redirection or scattering.

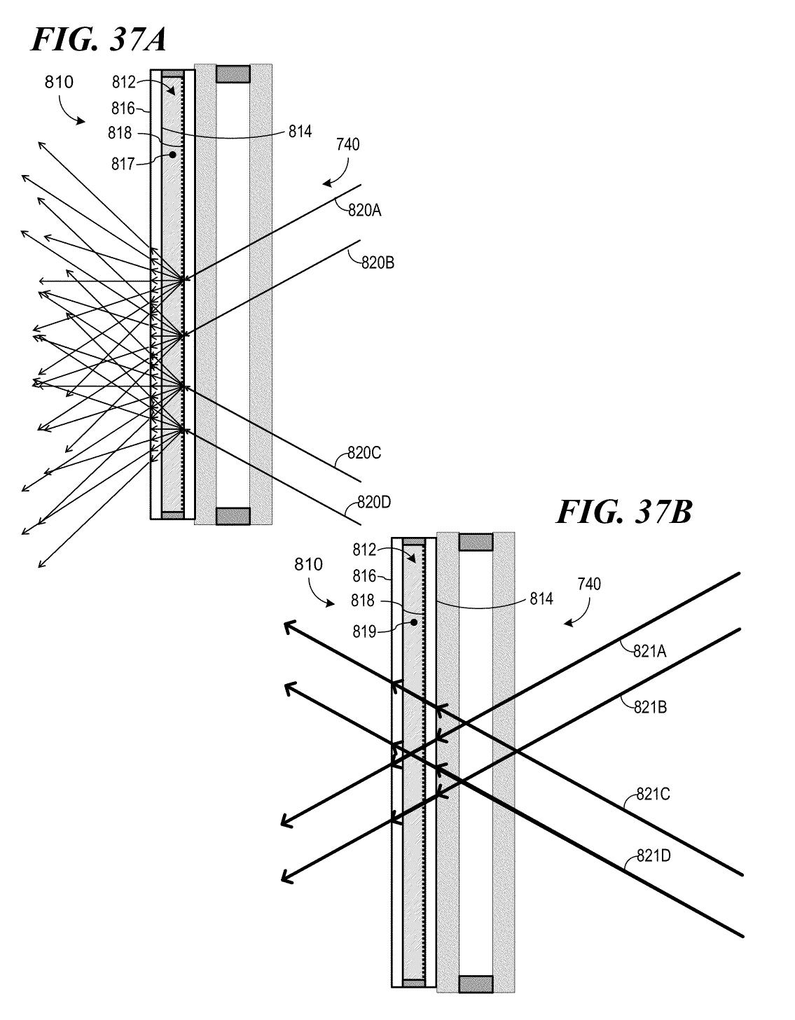

Turning now to FIG. 37A-37B, a switchable window apparatus 810 may comprise a retro-fit kit, such as shown in FIGS. 16-21, on an interior side of the existing window 740, installed over an existing window unit 740, which may not have any reflective glazing, for example. In an obstructed condition shown in FIG. 37A, a sealed cavity 812 may be formed between a first transparent substrate 814 and a second transparent substrate 816. A lens element 818 may be mounted within the cavity 812, supported on an interior surface of the first transparent substrate 814. The cavity 812 may be substantially filled with a non-matching fluid 817, such as air for example. The fluid 817 in contact with lens element 818 may be a poor match for the refractive index of the lens material, having a substantially different index of refraction than that of the lens element 818. Incident light rays 820 A-820 B or 820C-820D striking the exterior of existing window unit 740 may pass through the existing window unit without significant distortion, redirection or scattering. Light rays 820 A-820 B or 820C-820D striking the lens element 818 may be refracted at various different angles depending upon the location and angle of incidence of each light ray 820 A-820 B or 820C-820D upon the lens element 818, and the configuration of the effective surface of the lens element 818. A significant portion of light rays 820 A-820 B or 820C-820D striking the lens element 818 may be diffused. Light rays passing through the switchable window apparatus 810 may experience significant redirection or scattering.

In a transparent condition shown in FIG. 37B, the cavity 812 may be substantially filled with an index-matching fluid 819. The fluid 819 in contact with the lens element 818 may be a good match for the refractive index of the lens material, having an index of refraction substantially equal to that of the lens element 818. A light ray 821 A-821 B or 821C-821D striking the existing window unit 740 may pass through the existing window unit 740 without significant distortion, redirection or scattering, and may pass through the lens element 818 and the index-matching fluid 819 without noticeable effect since the indices of refraction of the lens element 818 and the fluid 819 may all be substantially equal. Light rays may pass through the switchable window apparatus 810 without significant redirection or scattering.

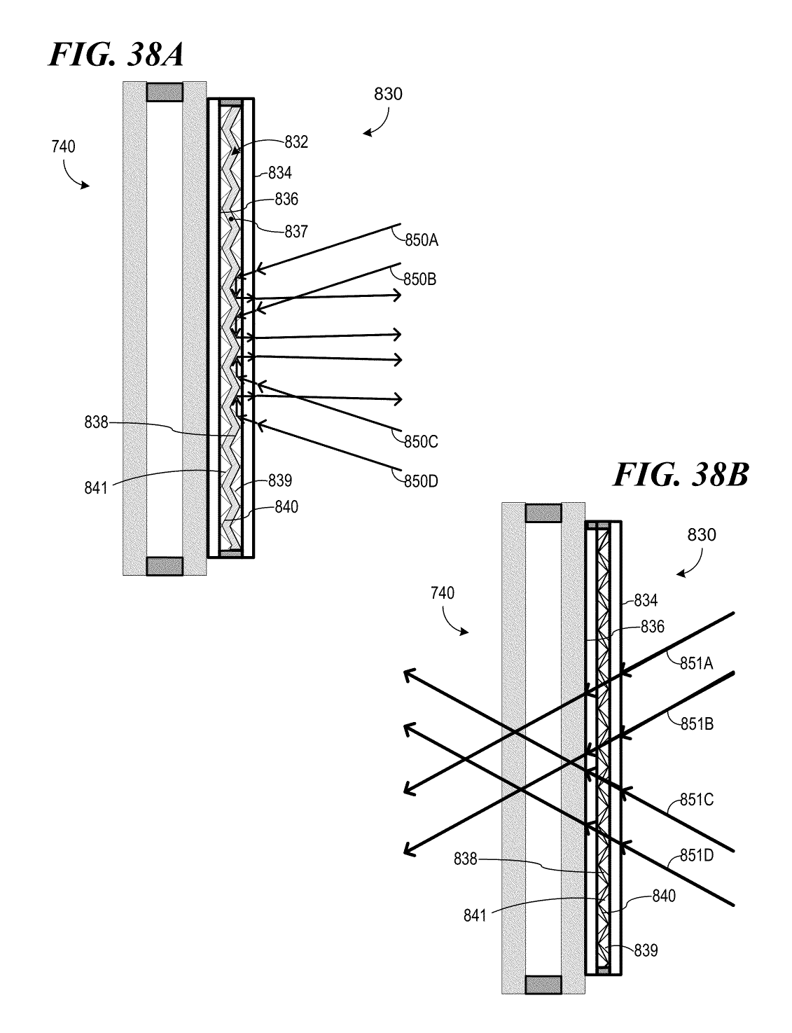

Turning now to FIG. 38A-38B, a switchable window apparatus 830 may comprise a retro-fit kit, on an exterior side of the existing window 740, installed over an existing window unit 740, which may not have any reflective glazing, for example. In an obstructed condition shown in FIG. 38A, a cavity 832 may be formed between a first transparent substrate 834 and a second transparent substrate 836. A first lens element 838 may be mounted within the cavity 832, supported on an interior surface of the first transparent substrate 834. A second lens element 840 may be mounted within the cavity 832, supported on an interior surface of the second transparent substrate 834. The first lens element 838 may be an array of prismatic lenses, having many facets 839. The second lens element 840 may be an array of prismatic lenses, having many facets 841, and may be complementary to first lens element 838. The cavity 832 may be substantially filled with a non-matching fluid 837, such as air for example, and need not be sealed. The first and second transparent substrates 834, 836 may be separated by some distance such that first and second lens elements 838, 840 are not in contact with each other. Light rays 850A-850B or 850C-850D may be scattered in a non-uniform manner by surfaces of the first lens element 838. Because of the specific orientation of the many facets 839 of the retro-reflective lens element 838, incident light, such as light rays 850A and 850B, experience total internal reflection encountering a material interface going from a higher to lower refractive index, such as passing through the polymer lens element 838 into the non-matching fluid 837, such as air for example. The retro-reflective lens element 838 may reduce transmission through the lens element 838 because the retro-reflective lenses may not scatter light, but may reduce, in some cases completely, the quantity of light passing through the lens element 838. The light may be redirected in a non-uniform manner by the facets 839 of lens element 838, and returns through the first transparent substrate 834. Light rays passing through the switchable window apparatus 830 may experience significant redirection or scattering.

In a transparent condition shown in FIG. 38B, the first transparent substrate 834 and the second transparent substrate 836 are brought close together such that first and second lens elements 838, 840 may be in substantial contact with each other. The cavity 832 may be compressed until there is no longer a cavity between the first and second lens elements 838, 840. Light rays 851A-851B or 851C-851D striking the outer surface of the first transparent substrate 834 may pass through the first transparent substrate 834 without significant distortion, redirection or scattering. The light rays 851A-851B or 851C-851D may travel through the first lens element 838 and the second lens element 840 without noticeable effect since the indices of refraction of the first and second lens elements 838, 840 may be substantially equal. The light rays 851A-851B or 851C-851D may pass through the second transparent substrate 836 without significant further distortion, redirection or scattering. Light rays 851A-851B or 851C-851D may pass through the existing window unit 740 without additional significant distortion, redirection or scattering. The angle of incidence of the light ray entering the switchable window apparatus 830 may be substantially equal to the angle of refraction of the light ray exiting the switchable window apparatus 830. Light rays may pass through the switchable window apparatus 830 without significant redirection or scattering.

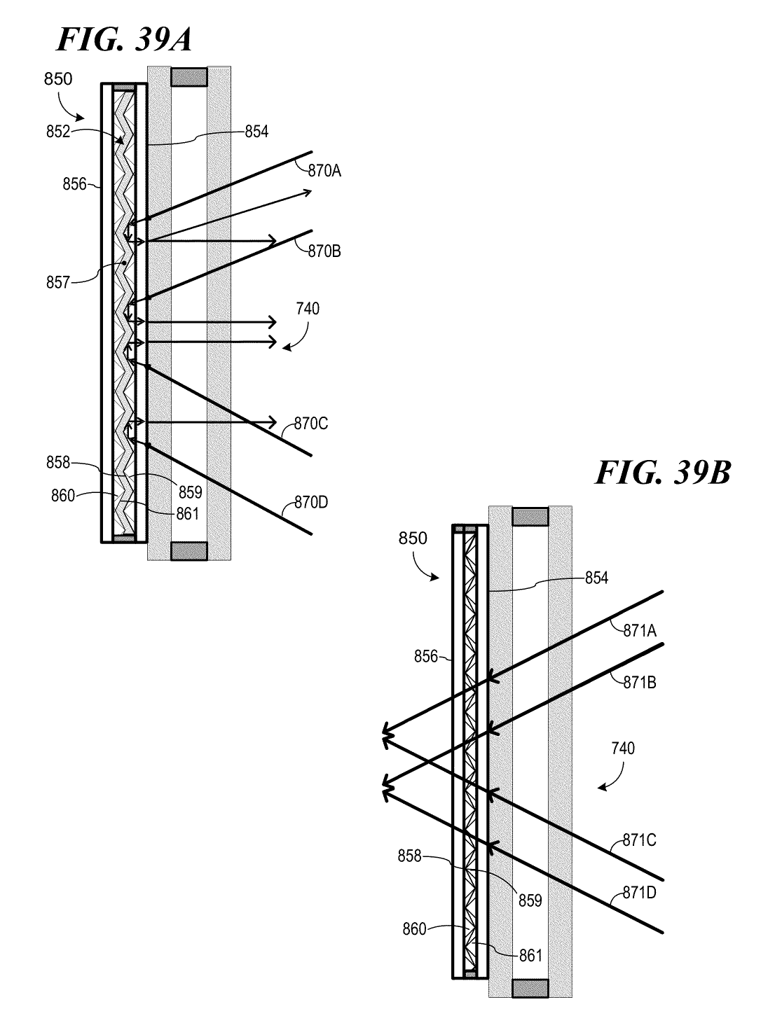

Turning now to FIG. 39A-39B, a switchable window apparatus 850 may comprise a retro-fit kit, on an interior side of the existing window 740, installed over an existing window unit 740, which may not have any reflective glazing, for example. In an obstructed condition shown in FIG. 39A, a cavity 852 may be formed between a first transparent substrate 854 and a second transparent substrate 856. A first lens element 858 may be mounted within the cavity 852, supported on an interior surface of the first transparent substrate 854. A second lens element 860 may be mounted within the cavity 852, supported on an interior surface of the second transparent substrate 854. The first lens element 858 may be an array of prismatic lenses, having many facets 859. The second lens element 860 may be an array of prismatic lenses, having many facets 861, and may be complementary to first lens element 858. The cavity 852 may be substantially filled with a non-matching fluid 857, such as air for example, and need not be sealed. The first and second transparent substrates 854, 856 may be separated by some distance such that first and second lens elements 858, 860 are not in contact with each other. Incident light rays 870A-870b or 870C-870D striking the exterior of existing window unit 740 may pass through the existing window unit without significant distortion, redirection or scattering. Light rays 870A-870b or 870C-870D striking the first lens element 858 may be scattered in a non-uniform manner by surfaces of the first lens element 858. Because of the specific orientation of the many facets 859 of the retro-reflective lens element 858, incident light, such as light rays 870A-870b or 870C-870D, may experience total internal reflection encountering a material interface going from a higher to lower refractive index, such as passing through the polymer lens element 858 into the non-matching fluid 857, such as air for example. The retro-reflective lens element 858 may reduce transmission through the lens element 858 because the retro-reflective lenses may not scatter light, but may reduce, in some cases completely, the quantity of light passing through the lens element 858. The light may be redirected in a non-uniform manner by the facets 859 of lens element 858, and returns through the first transparent substrate 847. Light rays passing through the switchable window apparatus 850 may experience significant redirection or scattering.

In a transparent condition shown in FIG. 39B, the first transparent substrate 854 and the second transparent substrate 856 may be brought close together such that first and second lens elements 858, 860 are in substantial contact with each other. The cavity 852 may be compressed until there is no longer a cavity between the first and second lens elements 858, 860. Light rays 871A or 871B striking the outer surface of the first transparent substrate 854 may refract slightly at the interface between air and glass (for example). Light rays 871A or 871B may pass through the existing window unit 740 without significant distortion, redirection or scattering. The light rays 871A-871B or 871C-871D may travel through the first lens element 858 and the second lens element 860 without noticeable effect since the indices of refraction of the first and second lens elements 858, 860 may be substantially equal. The angle of incidence of the light ray entering the switchable window apparatus 850 may be substantially equal to the angle of refraction of the light ray exiting the switchable window apparatus 850. Light rays may pass through the switchable window apparatus 850 without significant redirection or scattering.

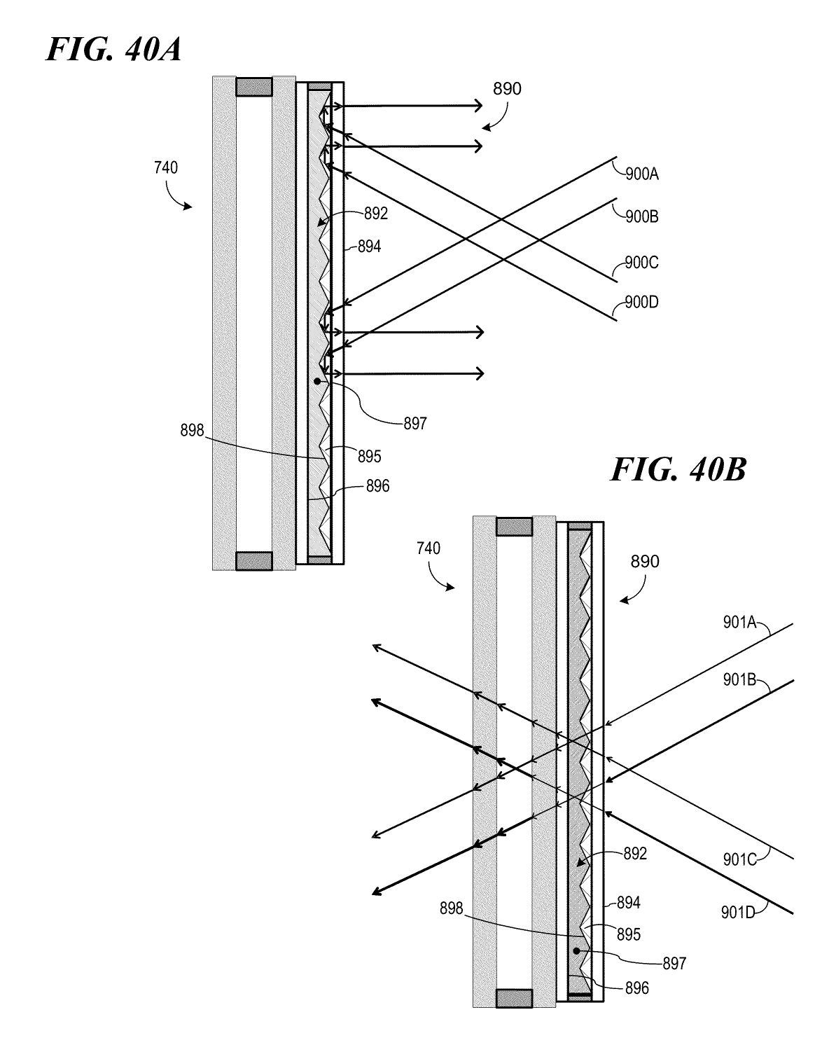

Turning now to FIG. 40A-40B, a switchable window apparatus 890 may comprise a retro-fit kit, on an exterior side of the existing window 740, installed over an existing window unit 740, which may not have any reflective glazing, for example. The switchable window apparatus 890 may have a cavity 892 formed between a first transparent substrate 894 and a second transparent substrate 896. A lens element 898 may be mounted within the cavity 892, supported on an interior surface of the first transparent substrate 894. The lens element 898 may be an array of prismatic lenses, having many facets 895, arranged as a retro-reflector. The cavity 892 may be substantially filled with a non-matching fluid 897, such as air for example, or an index-matching fluid 899 such as hereinbefore described. In an obstructed condition shown in FIG. 40A, the cavity 892 may be substantially filled with the non-matching fluid 897, and light rays 900A-900B or 900C-900D are scattered in a non-uniform manner by surfaces of the lens element 898. Because of the specific orientation of the many facets 895 of the retro-reflective lens element 898, incident light, such as light rays light rays 900A-900B or 900C-900D, may experience total internal reflection encountering a material interface going from a higher to lower refractive index, such as passing through the polymer lens element 898 into the non-matching fluid 897, such as air for example. The retro-reflective lens element 898 may reduce transmission through the lens element 898 because the retro-reflective lenses may not scatter light, but may reduce, in some cases completely, the quantity of light passing through the lens element 898. The light may be redirected in a non-uniform manner by the facets 895 of lens element 698, and may return through the first transparent substrate 894. Light rays passing through the switchable window apparatus 890 may experience significant redirection or scattering.

In a transparent condition shown in FIG. 40B, the cavity 892 may be substantially filled with index-matching fluid 899. A light ray 901A-901B or 901C-901D striking the outer surface of the first transparent substrate 894 may refract slightly at the interface between air and glass (for example). The light rays 901A-901B or 901C-901D may travel through the lens element 898 and the index-matching fluid 899 without noticeable effect since the indices of refraction of the lens element 898 and the index-matching fluid 899 may be substantially equal. The light rays 901A-901B or 901C-901D may refract slightly at the interface between the second transparent substrate 896 and air. Light rays 901A-901B or 901C-901D may pass through the existing window unit 740 without additional significant distortion, redirection or scattering. The angle of incidence of the light ray entering the switchable window apparatus 890 may be substantially equal to the angle of refraction of the light ray exiting the switchable window apparatus 890. Light rays may pass through the switchable window apparatus 890 without significant redirection or scattering.

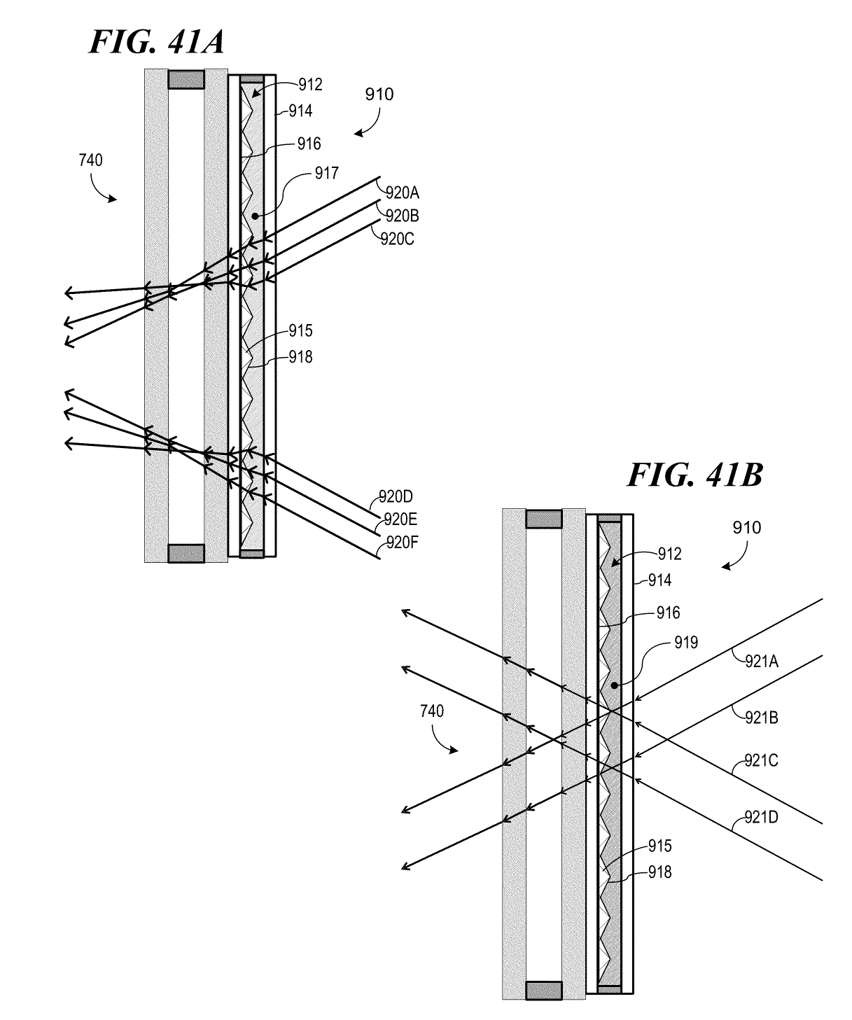

Turning now to FIG. 41A-41B, a switchable window apparatus 910 may comprise a retro-fit kit, on an exterior side of the existing window 740, installed over an existing window unit 740, which may not have any reflective glazing, for example. A cavity 912 may be formed between a first transparent substrate 914 and a second transparent substrate 916. A lens element 918 may be mounted within the cavity 912, supported on an interior surface of the second transparent substrate 916. The lens element 918 may be an array of prismatic lenses, having many facets 915. The cavity 912 may be substantially filled with a non-matching fluid 917, such as air for example, or an index-matching fluid 919 such as hereinbefore described. In an obstructed condition shown in FIG. 41A, the cavity 912 may be substantially filled with the non-matching fluid 917, and light rays 920A-920C or 920D-920F may be scattered in a non-uniform manner by surfaces of the lens element 918. Because of the specific orientation of the many facets 915 of the lens element 918, incident light, such as light rays 920A-920C or 920D-920F, may experience refraction passing through the non-matching fluid 917, such as air for example, into polymer lens element 918. The light may be redirected in a non-uniform manner by the facets 915 of lens element 918, and may pass through the second transparent substrate 916. Light rays 920A-920C or 920D-920F may pass through the existing window unit 740 without additional significant distortion, redirection or scattering. Light rays passing through the switchable window apparatus 910 may experience significant redirection or scattering.

In a transparent condition shown in FIG. 41B, the cavity 912 may be substantially filled with index-matching fluid 919. A light ray 921A-921B or 921C-921D striking the outer surface of the first transparent substrate 914 may pass through the first transparent substrate 914 without significant distortion, redirection or scattering. The light ray 921A-921B or 921C-921D may travel through the index-matching fluid 919 and the lens element 918 without noticeable effect since the indices of refraction of the lens element 918 and the index-matching fluid 919 may be substantially equal. The light ray 921A-921B or 921C-921D may refract slightly at the interface between the second transparent substrate 916 and air. Light rays 921A-921B or 921C-921D may pass through the existing window unit 740 without additional significant distortion, redirection or scattering. The angle of incidence of the light ray entering the switchable window apparatus 910 may be substantially equal to the angle of refraction of the light ray exiting the switchable window apparatus 910. Light rays may pass through the switchable window apparatus 910 without significant redirection or scattering.

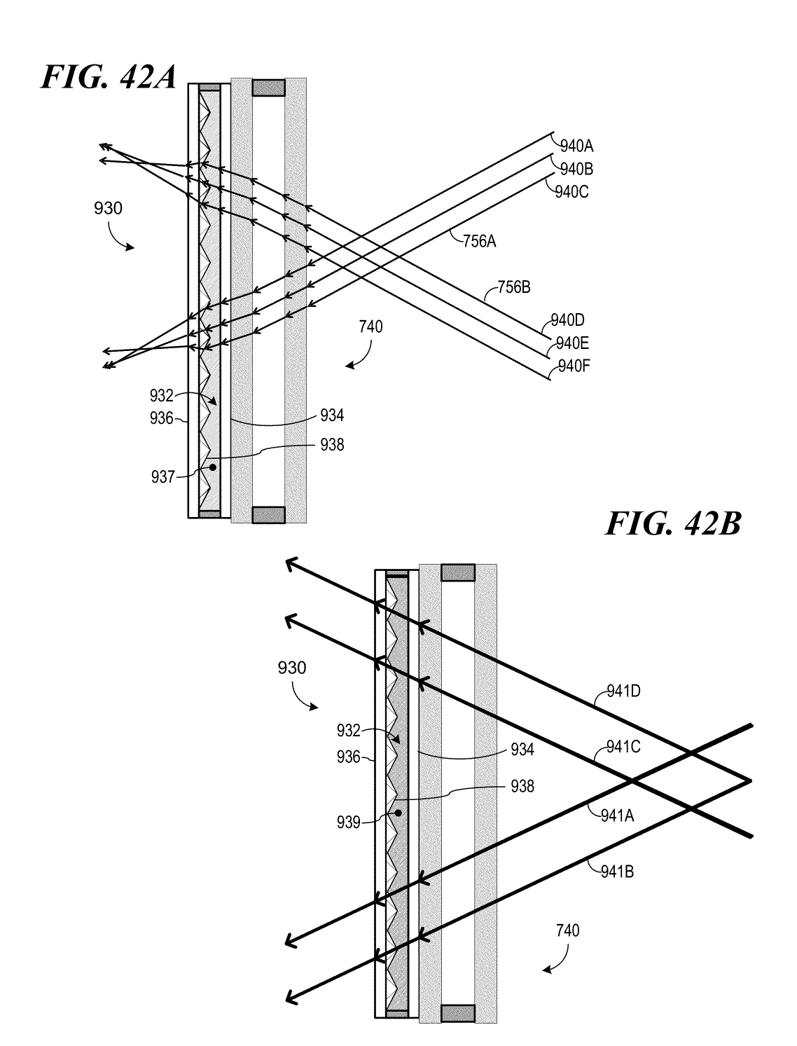

Turning now to FIG. 42A-42B, a switchable window apparatus 930 may comprise a retro-fit kit, on an interior side of the existing window 740, installed over an existing window unit 740, which may not have any reflective glazing, for example. In an obstructed condition shown in FIG. 42A, a sealed cavity 932 may be formed between a first transparent substrate 934 and a second transparent substrate 936. A lens element 938 may be mounted within the cavity 932, supported on an interior surface of the second transparent substrate 936. The cavity 932 may be substantially filled with a non-matching fluid 937, such as air for example. The fluid 937 in contact with lens element 938 may be a poor match for the refractive index of the lens material, having a substantially different index of refraction than that of the lens element 938. Incident light rays 940A-940C or 940D-940F striking the exterior of existing window unit 740 may pass through the existing window unit without significant distortion, redirection or scattering. Light rays 940A-940C or 940D-940F striking the lens element 938 may be refracted at various different angles depending upon the location and angle of incidence of each light ray 940A-940C or 940D-940F upon the lens element 938, and the configuration of the effective surface of the lens element 938. A significant portion of light rays 940A-940C or 940D-940F striking the lens element 938 may be diffused. Light rays passing through the switchable window apparatus 930 may experience significant redirection or scattering.

In a transparent condition shown in FIG. 42B, the cavity 932 may be substantially filled with index-matching fluid 939. Incident light rays 941A-941B or 941C-941D striking the exterior of existing window unit 740 may pass through the existing window unit without significant distortion, redirection or scattering. A light rays 941A-941B or 941C-941D striking the first transparent substrate 934 pass through the first transparent substrate 934 without significant distortion. The light rays 941A-941B or 941C-941D may travel through the index-matching fluid 939 and the lens element 938 without noticeable effect since the indices of refraction of the lens element 938 and the index-matching fluid 939 may be substantially equal. The light rays 941A-941B or 941C-941D B may pass through the second transparent substrate 936 without significant distortion r. The angle of incidence of a light ray entering the switchable window apparatus 930 may be substantially equal to the angle of refraction of the light ray exiting the switchable window apparatus 930. Light rays may pass through the switchable window apparatus 930 without significant redirection or scattering.

Turning now to FIG. 43A-43B, a switchable window apparatus 950 may comprise a retro-fit kit, on an interior side of the existing window 740, installed over an existing window unit 740, which may not have any reflective glazing, for example. In an obstructed condition shown in FIG. 43A, a sealed cavity 952 may be formed between a first transparent substrate 954 and a second transparent substrate 956. A lens element 958 may be mounted within the cavity 952, supported on an interior surface of the first transparent substrate 954. The cavity 952 may be substantially filled with a non-matching fluid 957, such as air for example. The fluid 957 in contact with lens element 958 may be a poor match for the refractive index of the lens material, having a substantially different index of refraction than that of the lens element 958. Incident light rays 960A-960B or 960C-960D striking the exterior of existing window unit 740 may pass through the existing window unit without significant distortion, redirection or scattering. Light rays 960A or 960B may be scattered in a non-uniform manner by surfaces of the lens element 958. Because of the specific orientation of the many facets 955 of the retro-reflective lens element 958, incident light, such as light rays 960A-960B or 960C-960D, may experience total internal reflection encountering a material interface going from a higher to lower refractive index, such as passing through the polymer lens element 958 into the non-matching fluid 957, such as air for example. The light may be redirected in a non-uniform manner by the facets 955 of lens element 958, and may return through the first transparent substrate 954. Light rays entering the switchable window apparatus 950 may experience significant redirection or scattering.

In a transparent condition shown in FIG. 43B, the cavity 952 may be substantially filled with index-matching fluid 959. Incident light rays 961A or 961B striking the exterior of existing window unit 740 may pass through the existing window unit without significant distortion, redirection or scattering. A light ray 961A-961B or 961C-961D may travel through the lens element 958 and the index-matching fluid 959 without noticeable effect since the indices of refraction of the lens element 958 and the index-matching fluid 958 may be substantially equal. The light ray 961A-961B or 961C-961D may refract slightly at the interface between the second transparent substrate 956 and air. The angle of incidence of the light ray entering the switchable window apparatus 950 may be substantially equal to the angle of refraction of the light ray exiting the switchable window apparatus 950. Light rays may pass through the switchable window apparatus 950 without significant redirection or scattering.

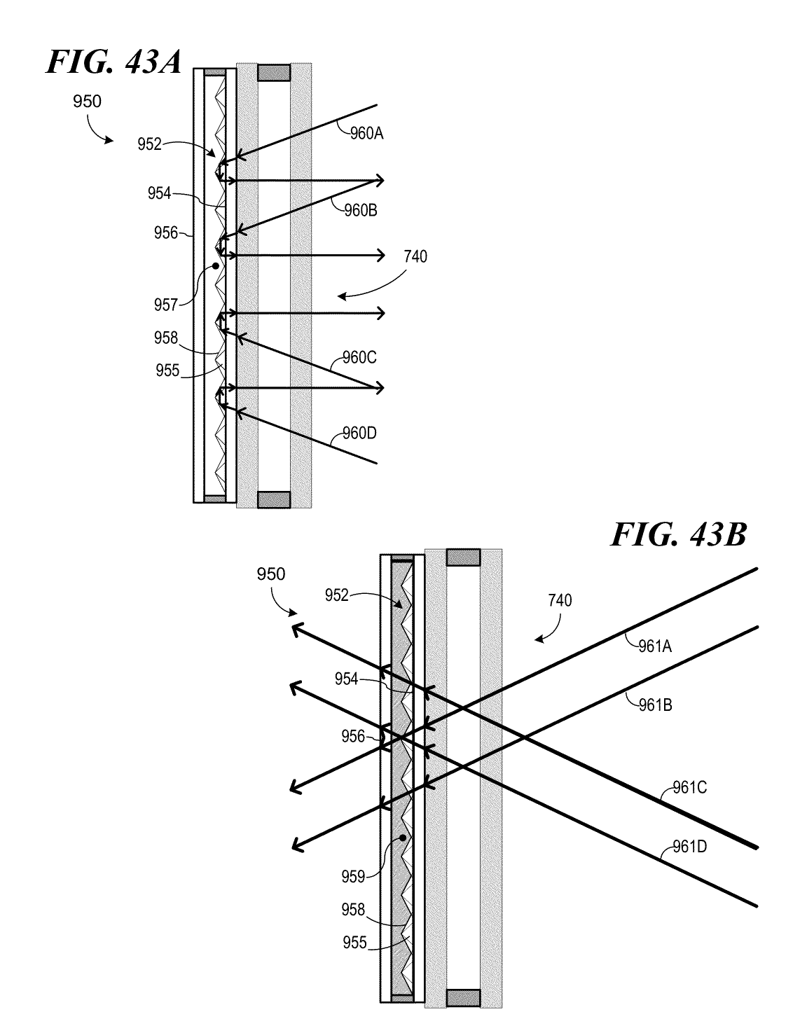

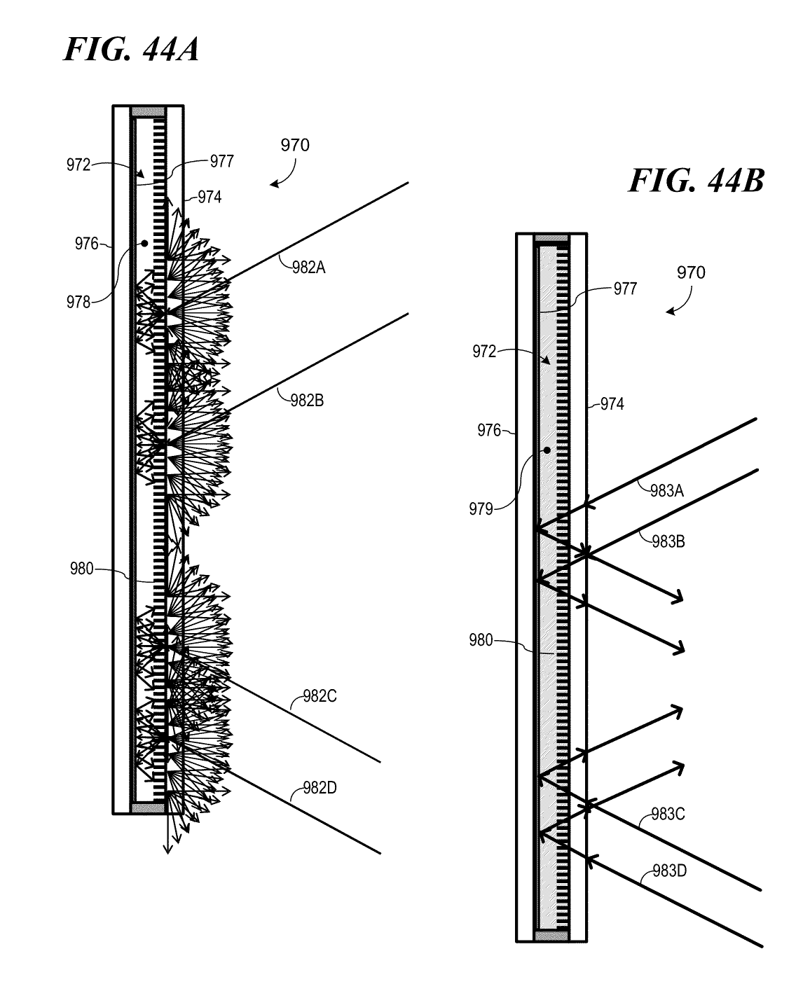

Turning now to FIG. 44B-44B, one effect of a switchable window unit is illustrated in simple light ray diagrams. FIG. 44A illustrates a switchable window apparatus 970, such as may be used as an original or replacement architectural feature or as a retro-fit apparatus, in which a cavity 972 is formed between two transparent substrates 974, 976. A layer of reflective glazing 977 may be applied to a surface of the second transparent substrate 976. In an obstructed condition, the cavity 972 may be substantially filled with a fluid 978 having an index of refraction that does not match an index of refraction of a lens element 980 mounted within the cavity 972, such as air, other gases, or a non-matching liquid. In the obstructed condition, light rays 982A-982B or 982C-982D may be parallel approaching the switchable window apparatus 970. Light rays 982A-982B or 982C-982D entering the switchable window apparatus striking the outer surface of the first transparent substrate 974 may pass through the transparent substrate 974 without significant distortion, redirection or scattering. The light rays 982A-982B or 982C-982D may be scattered in a non-uniform manner by surfaces of the lens element 980, and may reflect from the reflective glazing 977 on a surface of the second transparent substrate 976. Light rays passing through the switchable window apparatus 970 may experience significant redirection or scattering. Parallel light rays passing into the switchable window apparatus 970 may no longer be parallel when exiting the switchable window apparatus 970.

In a transparent condition shown in FIG. 44B, the cavity 972 may be substantially filled with a fluid 979 having an index of refraction that matches an index of refraction of the lens element 980 mounted within the cavity 972, such as an index-matching liquid as hereinbefore described. In the transparent condition, Light rays 983A-983B or 983C-983D striking the outer surface of the first transparent substrate 974 may pass through the transparent substrate 974 without significant distortion, redirection or scattering. The light rays 983A-983B or 983C-983D may travel through the lens element 980 and the index-matching fluid 979 without noticeable effect since the indices of refraction of the transparent the lens element 980 and the index-matching fluid 979 may be substantially equal. Light rays may pass through the switchable window apparatus 970 and still experience some specular reflection or glare. Parallel light rays passing through the switchable window apparatus 970 may still be parallel when exiting the switchable window apparatus 970.

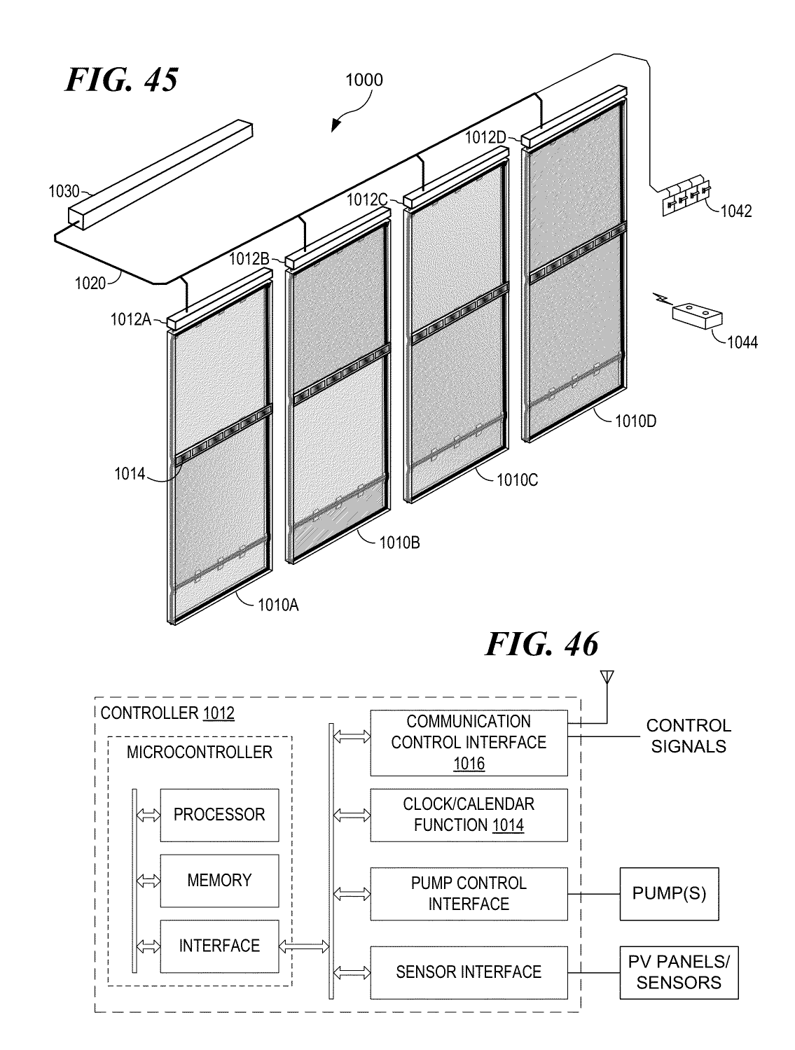

Turning now to FIGS. 45-46, a system 1000 of switchable window units 1010A. 1010B, 1010C, 1010D and their associated window controllers 1012A, 1012B, 1012C, 1012D may be connected via one or more communications links 1020 to a system controller 1030. The switchable window units 1010A. 1010B, 1010C, 1010D may be similar to any of the preceding switchable window configurations described hereinbefore. The switchable window units 1010A. 1010B, 1010C, 1010D may be original equipment switchable windows or may be existing window units having a retro-fit kit installed. The switchable window units 1010A. 1010B, 1010C, 1010D may have a layer of reflective glazing on either the inside surface or the outside surface of any transparent substrate, such as a pane of glass or the like, Lens elements used in the switchable window units 1010A. 1010B, 1010C, 1010D may be any lens element having a desired optical effect of distorting, diffusive, or otherwise redirecting incident light in a non-uniform manner to obstruct the light. The lens elements may be mounted on either an inside surface of an exterior transparent substrate or an inside surface of an interior transparent substrate.

A window controller such as 1012A, 1012B, 1012C, 1012D may be located in a header box above each corresponding switchable window unit 1010A. 1010B, 1010C, 1010D, and may operate independently of other window controllers. A typical window controller 1012, shown in FIG. 46, may have a clock function 1014 to control when to switch the window unit from an obstructed condition to a transparent condition and vice versa. The clock function may adjust the switching time depending upon the day of the year, to account for season variations in incident light upon the window unit 1010. The window controller 1012 may have a wireless communications receiver 1016 for receiving switching signals from a remote controller, such a system controller 1030 or from an individual switch 1042 or hand-held remote control device 1044. Alternatively, individual switches associated with at least one of each switchable window unit 1010A. 1010B, 1010C, 1010D may be located in relative proximity to the associated window unit and be in communication with control system 1030, which may relay control signals via communications link 1020 to the switchable window units 1010A. 1010B, 1010C, 1010D.

The communications links 1020 may be configured to use conventional electrical wiring to interconnect the window units 1010A. 1010B, 1010C, 1010D to the system controller 1030. Alternatively, any suitable wireless communications protocol, such as Bluetooth, for example, may be utilized to interconnect the window units 1010A. 1010B, 1010C, 1010D to the system controller 1030. Each of the switchable window units 1010A. 1010B, 1010C, 1010D may utilize sensor input to determine when to switch from an obstructed condition to a transparent condition and vice versa. For example, an optical sensor 1014 may be provided on each switchable window unit 1010A. 1010B, 1010C, 1010D, for measuring the amount of incident sunlight. The window controller 1012 may be programmed to switch to an obstructed condition when the incident light reaches a certain level of intensity, and may be programmed to switch back to a transparent condition when the incident light returns below a preset level of intensity. In certain configurations, the optical sensor 1014 may be a photo-voltaic panel that provides electrical energy to the window control system 1010, and the intensity of incident light may be calculated based upon the energy output of the photo-voltaic panel.

Input conditions may be prioritized by the window controller 1010 or by the system controller 1030 so that certain conditions or command may take precedent over other conditions or commands. For example, a switchable window unit 1010 or a system 1000 of switchable units may be programmed to switch to the obstructed condition from mid-morning until late-afternoon according to the time of day as controlled by a clock function 1014. The clock function 1014 may be implemented as a hardware function or as a software function. Window controller 1012 or system controller 1030 may be programmed to override the clock function programming if a certain level of incident light intensity is measured from sensor input or calculated from photo-voltaic panel output before the normal mid-morning switching time or the normal mid-afternoon switching time. In such instances, the mid-morning switching time may be advanced and the switch to an obstructed condition may happen earlier, or the mid-afternoon switching time may be delayed and the switch to transparent condition may be delayed. Window controller 1012 or system controller 1030 by be programmed to override both the clock function programming and the sensor-input programming upon receipt of a command from a switch or remote control device, to the effect that a switchable window unit 1010 may be placed in the obstructed condition or in the transparent condition at any time by a user, regardless of the time of day or the level of intensity of incident light. Alternatively, the sensor-input program may be given top priority to the effect the switchable window units 1010 cannot be placed in transparent mode if the level of incident light has reached a certain level, regardless of the time of day or input commands from users. In certain instances, the clock function may be given top priority, to the effect that switching between obstructed and transparent conditions, and vice versa, can only happen at certain times of the day regardless of incident light conditions or user commands.

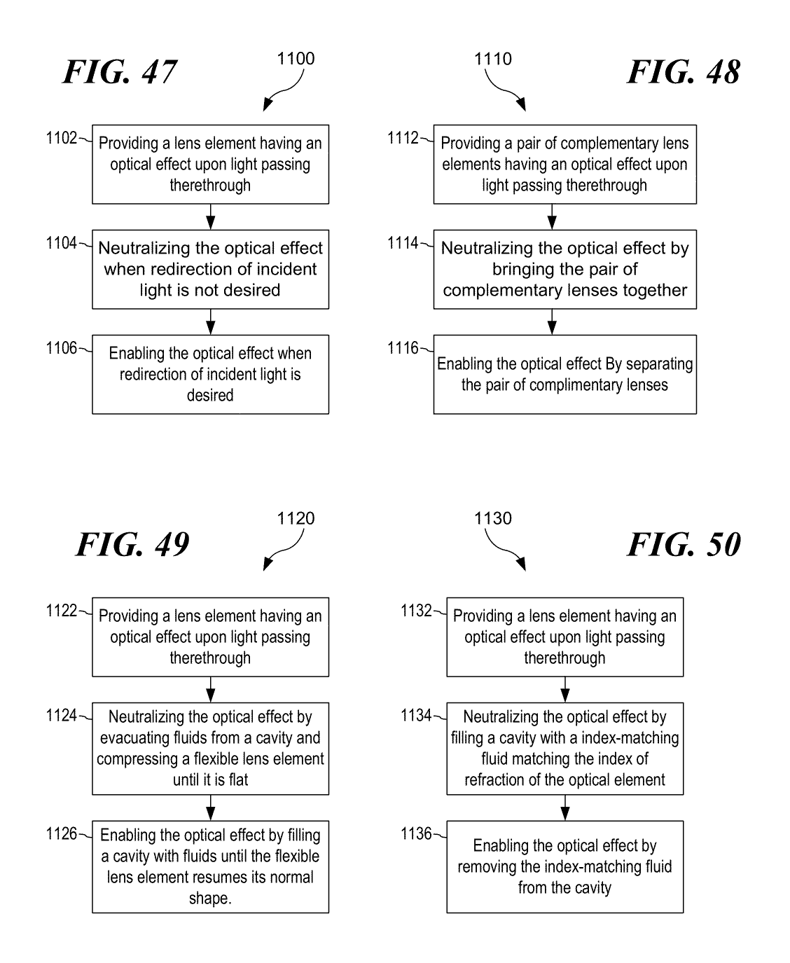

Turning now to FIGS. 47-50, several methods may be utilized to provide a switchable window apparatus, among which are the methods illustrated in FIGS. 47-50. FIG. 47 illustrates the method 1100, which in step 1102 provides a lens element having an optical effect upon light passing therethrough; in step 1104 neutralizes the optical effect when redirection of incident light is not desired; and in step 1106 enables the optical effect.

FIG. 48 illustrates method 1110, which in step 1112 provides a pair of complementary lens elements having an optical effect upon light passing therethrough; in step 1114 neutralizes the optical effect by bringing the pair of complementary lenses together; and in step 1116 enables the optical effect by separating the pair of complimentary lenses. FIG. 49 illustrates method 1120, which in step 1122 provides a flexible lens element having an optical effect upon light passing therethrough; in step 1124 neutralizes the optical effect by evacuating fluids from a cavity adjacent the lens element and compressing the flexible lens element until it is flat; and in step 1126 enables the optical effect by filling a cavity with fluids until the flexible lens element resumes its normal shape. FIG. 50 illustrates method 1130, which in step 1132 provides a lens element having an optical effect upon light passing therethrough; in step 1134 neutralizes the optical effect by filling a cavity adjacent the lens element with an index-matching fluid matching the index of refraction of the optical element; and in step 1136 enables the optical effect by removing the index-matching fluid from the cavity adjacent the lens element.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

I claim:

1. A window apparatus comprising:
at least one transparent substrate and a lens element having an optical effect upon incident light;
an apparatus configured to disable the optical effect and neutralize the lens element;
wherein the apparatus may be operated in reverse to enable the optical effect and restore the lens element to effectiveness.

2. A method for redirecting incident light, comprising the steps of:
providing a lens element having an optical effect upon light passing therethrough;
neutralizing the optical effect when redirection of incident light is not desired; and
enabling the optical effect when redirection of incident light is desired.

3. The method of claim 2, wherein the lens element comprises a pair of complementary lenses; and
wherein the step of neutralizing the optical effect comprises bringing together the pair of complementary lenses into intimate contact, and wherein the step of enabling the optical effect comprises separating the pair of complimentary lenses such that the pair of complimentary lenses are no longer in intimate contact.

4. The method of claim 2, wherein the lens element has a degree of elasticity depending upon the material from which the lens element is made and allowing for repeated deformations, the lens element having a certain index of refraction depending upon a material from which the lens element is made, the lens element being disposed within a cavity between first and second transparent substrates; and
wherein the step of neutralizing the optical effect comprises evacuating a cavity between the lens element and a transparent substrate, and wherein the step of enabling the optical effect comprises filling the cavity with a fluid having an index of refraction that does not match the index of refraction of the lens element.

5. The method of claim 2, wherein the lens element has a certain index of refraction depending upon a material from which the lens element is made, the lens element being disposed within a cavity between first and second transparent substrates; and
wherein the step of neutralizing the optical effect comprises filling the cavity with a fluid having an index of refraction that matches, or is at least approximately equal to, the index of refraction of the lens element, and wherein the step of enabling the optical effect comprises filling the cavity with a fluid having an index of refraction that does not match the index of refraction of the lens element.

6. A switchable window apparatus, comprising:
a first transparent substrate;
a second transparent substrate;
a cavity disposed between the first and second transparent substrates;
a glazing material disposed near a periphery of each of the first and second transparent substrates, the glazing material being further disposed between the first and second transparent substrates and sealing the cavity therebetween;
a lens element having an optical effect upon light passing therethrough, the lens element having a certain index of refraction depending upon a material from which the lens element is made, the lens element being disposed within the cavity between the first and second transparent substrates;
a first port in fluid communication with the cavity between the first and second transparent substrates;
a second port in fluid communication with the cavity between the first and second transparent substrates;
a quantity of fluid having an index of refraction that does not match the index of refraction of the material from which the lens element is made;
a quantity of fluid having an index of refraction that matches, or is at least approximately equal to, the index of refraction of the material from which the lens element is made; and
a pumping apparatus coupled to at least one of the first port and the second port for causing at least one fluid to enter or exit the cavity between the first and second transparent substrates.

7. The apparatus of claim 6, wherein the first port is configured to accommodate a flow of fluid between the cavity and a reservoir.

8. The apparatus of claim 6, wherein the second port is configured to accommodate a flow of fluid between the cavity and an atmosphere outside the cavity.

9. The apparatus of claim 6, wherein the pumping apparatus is a liquid pump configured to pump index-matching fluid into or out of the cavity.

10. The apparatus of claim 6, wherein the pumping apparatus is a vacuum pump configured to remove air of other gasses from the sealed cavity, thereby drawing fluid into the cavity via suction.

11. The apparatus of claim 6, wherein the switchable window apparatus may be placed in a transparent condition by filling the cavity with a fluid having an index of refraction that matches, or is at least approximately equal to, the index of refraction of the material from which the lens element is made fluid until the lens element is fully covered.

12. The apparatus of claim 6, wherein the switchable window apparatus may be placed in an obstructed condition by filling the cavity with a fluid possessing an index of refraction that does not match the index of refraction of the lens element.

13. A method for redirecting incident light, comprising the steps of:
providing a switchable window apparatus having a lens element for redirecting incident light disposed within a sealed transparent cavity, wherein the lens element has a pre-determined index of refraction;
filling the cavity with an index-matching fluid having an index of refraction that matches, or is at least approximately equal to, the index of refraction of the lens element, such that any optical effect of the lens element is negated, and a portion of the incident light is directed in a first direction; and
filling the cavity with a second, non-index-matching fluid having an index of refraction that does not match the index of refraction of the lens element, such that the lens element exhibits an optical effect upon the incident light, thereby redirecting a portion of the incident light in other than the first direction.

14. The method of claim 13, wherein the optical effect of the lens element is diffusion of incident light upon the switchable window apparatus.

15. The method of claim 13, wherein the optical effect of the lens element is diffraction of incident light upon the switchable window apparatus.

16. The method of claim 13, wherein the optical effect of the lens element is refraction of incident light upon the switchable window apparatus.

17. The method of claim 13, wherein the optical effect of the lens element is reflection of incident light upon the switchable window apparatus.

14. A switchable window apparatus, comprising:
a first transparent substrate;
a second transparent substrate;
a cavity disposed near a periphery of each of the first and second transparent substrates, a glazing material being further disposed between the first and second transparent substrates and sealing the cavity therebetween;
a pair of lens elements having an optical effect upon light passing therethrough, the lens elements possessing complementary geometries such that the lens elements may be intimately contacted to form a homogenous volume of material, the lens elements having a certain index of refraction depending upon a material from which the lens element is made, the lens element being disposed within the cavity between the first and second transparent substrates, with one lens element contacting the first transparent substrate and one lens element contacting the second transparent substrate;
a port in fluid communication with the cavity between the first and second transparent substrates;
a pumping apparatus coupled to the port causing at least one fluid to enter or exit the cavity between the first and second transparent substrates.

15. A switchable window apparatus, comprising:
a first transparent substrate;
a second transparent substrate;
a cavity disposed near a periphery of each of the first and second transparent substrates, a glazing material being further disposed between the first and second transparent substrates and sealing the cavity therebetween;
a lens element having an optical effect upon light passing therethrough, the lens element having a degree of elasticity depending upon the material from which the lens element is made and allowing for repeated deformations, the lens elements having a certain index of refraction depending upon a material from which the lens element is made, the lens element being disposed within the cavity between the first and second transparent substrates; and
a port in fluid communication with the cavity between the first and second transparent substrates.

16. A window or window covering comprised of at least two lenses, the window being switchable between a first and second state, wherein the window transmits more electromagnetic radiation in the first state than in the second state, and wherein the window reflects or diffuses more electromagnetic radiation in the second state than in the first state.

17. A window or window covering according to claim 16 comprising lenses which are not separated by any distance or are separated by small distance relative to the area of the window, wherein the distance between the lenses is articulated by mechanical means.

18. A window or window covering according to claim 16, wherein mechanical articulation is achieved manually, pneumatically, hydraulically, with solenoids, electric motors, or a combination thereof.

19. A window or window covering according to claim 16, wherein each lens possesses one face that exhibits a two-dimensional or planar characteristic with a relatively smooth surface in comparison to the area of the window and the opposite face of each lens exhibits surface profiles, geometries, or a texture that causes the face to not exhibit a two-dimensional or planar characteristic.

20. A window or window covering according to claim 16, wherein the profiled face of the first lens exhibits a complementary geometry to the profiled face of the second lens, such that when the two lenses are brought into contact the gap between the two lenses is nonexistent or small enough so as to have a negligible effect on electromagnetic radiation passing through the lenses.

21. A window or window covering according to claim 16, wherein the lens is comprised of a material that is transparent to electromagnetic radiation and has an index of refraction greater than one, such as amorphous metal oxides, glasses, mineral crystals, or polymers such as polycarbonate, polymethyl methacrylate, polyethylene terephthalate, epoxies, urethanes, and silicones.

22. A window or window covering according to claim 16, wherein at least one lens exhibits a profiled face such that electromagnetic radiation traveling through the lens is refracted, totally internally refracted, or diffused.

23. A window or window covering according to claim 16, wherein the electromagnetic radiation that is refracted, totally internally refracted, or diffused exhibits a characteristic wavelength from about 10⁻⁸ meters to about 10⁻³ meters.
